(19) United States
(12) Patent Application Publication
(10) Pub. No.: US 2026/0135993 A1
(43) Pub. Date: May 14, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Na ZHANG, Beijing (CN); Kai Zhang, Los Angeles, CA (US); Hongbin Liu, Beijing (CN); Li Zhang, Los Angeles, CA (US)

(21) Appl. No.: 19/427,946

(22) Filed: Dec. 19, 2025

Related U.S. Application Data
(63) Continuation of application No. PCT/CN2024/100781, filed on Jun. 21, 2024.

(30) Foreign Application Priority Data
Jun. 21, 2023 (WO) PCT/CN2023/101660

(51) Int. Cl. H04N 19/105; H04N 19/136; H04N 19/176; H04N 19/196

(52) U.S. Cl. CPC H04N 19/105; H04N 19/136; H04N 19/176; H04N 19/196

(57) ABSTRACT

Embodiments of the present disclosure provide a solution for video processing. In a method for video processing, for a conversion between a current video block of a video and a bitstream of the video, a merge candidate of the current video block is determined. A value of a first variable is inherited by the merge candidate. The value of the first variable is adjusted based on a criterion. The conversion is performed based on the adjusted value of the first variable.

### CROSS REFERENCE TO RELATED APPLICATION

This application is a continuation of International Application No. PCT/CN2024/100781, filed on Jun. 21, 2024, which claims the benefit of International Application No. PCT/CN2023/101660 filed on Jun. 21, 2023. The entire contents of these applications are hereby incorporated by reference in their entireties.

### FIELDS

Embodiments of the present disclosure relates generally to video processing techniques, and more particularly, to inherited variable adjustment.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, a merge candidate of the current video block, a value of a first variable being inherited by the merge candidate: adjusting the value of the first variable based on a criterion; and performing the conversion based on the adjusted value of the first variable. In this way, the inherited variable value can be adjusted. Thus, the coding effectiveness and coding efficiency can be improved.

In a second aspect, another method for video processing is proposed. The method comprises: determining, for a conversion between a current video block of a video and a bitstream of the video, a merge candidate of the current video block: adjusting a value of local illumination compensation (LIC) indication of the merge candidate in a predefined step; and performing the conversion based on the adjusted value of the LIC indication. The coding effectiveness and coding efficiency can thus be improved.

In a third aspect, an apparatus for video processing is proposed. The apparatus comprises a processor and a non-transitory memory with instructions thereon. The instructions upon execution by the processor, cause the processor to perform a method in accordance with the first aspect or the second aspect of the present disclosure.

In a fourth aspect, a non-transitory computer-readable storage medium is proposed. The non-transitory computer-readable storage medium stores instructions that cause a processor to perform a method in accordance with the first aspect or the second aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: determining a merge candidate of a current video block of the video, a value of a first variable being inherited by the merge candidate: adjusting the value of the first variable based on a criterion; and generating the bitstream based on the adjusted value of the first variable.

In a sixth aspect, a method for storing a bitstream of a video is proposed. The method comprises: determining a merge candidate of a current video block of the video, a value of a first variable being inherited by the merge candidate: adjusting the value of the first variable based on a criterion: generating the bitstream based on the adjusted value of the first variable; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by an apparatus for video processing. The method comprises: determining a merge candidate of a current video block of the video: adjusting a value of local illumination compensation (LIC) indication of the merge candidate in a predefined step; and generating the bitstream based on the adjusted value of the LIC indication.

In an eighth aspect, a method for storing a bitstream of a video is proposed. The method comprises: determining a merge candidate of a current video block of the video: adjusting a value of local illumination compensation (LIC) indication of the merge candidate in a predefined step: generating the bitstream based on the adjusted value of the LIC indication; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure:

FIG. 3 illustrates a block diagram that illustrates an example video decoder, in accordance with some embodiments of the present disclosure:

FIG. 4 illustrates a schematic diagram of positions of spatial merge candidate:

FIG. 5 illustrates a schematic diagram of candidate pairs considered for redundancy check of spatial merge candidates:

FIG. 6 illustrates a schematic diagram of motion vector scaling for temporal merge candidate:

FIG. 7 illustrates a schematic diagram of candidate positions for temporal merge candidate, C₀ and C₁:

FIG. 8 illustrates a schematic diagram of VVC spatial neighboring blocks of the current block:

FIG. 9 illustrates a schematic diagram of virtual block in the ith search round:

FIG. 10 illustrates spatial neighboring blocks used to derive the spatial merge candidates:

FIG. 11 illustrates non-adjacent temporal neighboring blocks used to derive the non-adjacent temporal merge candidates:

FIG. 12A and FIG. 12B illustrate MMVD search point, respectively:

FIG. 13 illustrates top and left neighboring blocks used in CIIP weight derivation:

FIG. 14 illustrates template matching performs on a search area around initial MV:

FIG. 15A and FIG. 15B illustrate the division method for angular modes, respectively:

FIG. 16A and FIG. 16B illustrate control point based affine motion model, respectively:

FIG. 17 illustrates affine MVF per subblock:

FIG. 18 illustrates locations of inherited affine motion predictors:

FIG. 19 illustrates control point motion vector inheritance:

FIG. 20 illustrates locations of Candidates position for constructed affine merge mode:

FIG. 21 illustrates first HPT and the second HPT:

FIG. 22 illustrates spatial neighbors for deriving affine merge/AMVP candidates: (a) for deriving inherited candidates (b) for deriving the first type of constructed candidates:

FIG. 23 illustrates from non-adjacent neighbors to the first type of constructed affine merge/AMVP candidates:

FIG. 24 illustrates illustration of the neighboring 4×4 subblocks that are used for RMVF parameter derivation, where W and H are the width and height of the current CU:

FIG. 25A and FIG. 25B illustrate the SbTMVP process in VVC, where FIG. 25A illustrates spatial neighboring blocks used by ATMVP, and FIG. 25B illustrates deriving sub-CU motion field by applying a motion shift from spatial neighbor and scaling the motion information from the corresponding collocated sub-CUs:

FIG. 26 illustrates spatial neighboring positions used in IBC merge/AMVP list construction:

FIG. 27 illustrates padding candidates for the replacement of the zero-vector in the IBC list;

FIG. 28 illustrates IBC reference region depending on current CU position:

FIG. 29 illustrates a flowchart of a method for video processing in accordance with embodiments of the present disclosure:

FIG. 30 illustrates a flowchart of a method for video processing in accordance with embodiments of the present disclosure; and

FIG. 31 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc, may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

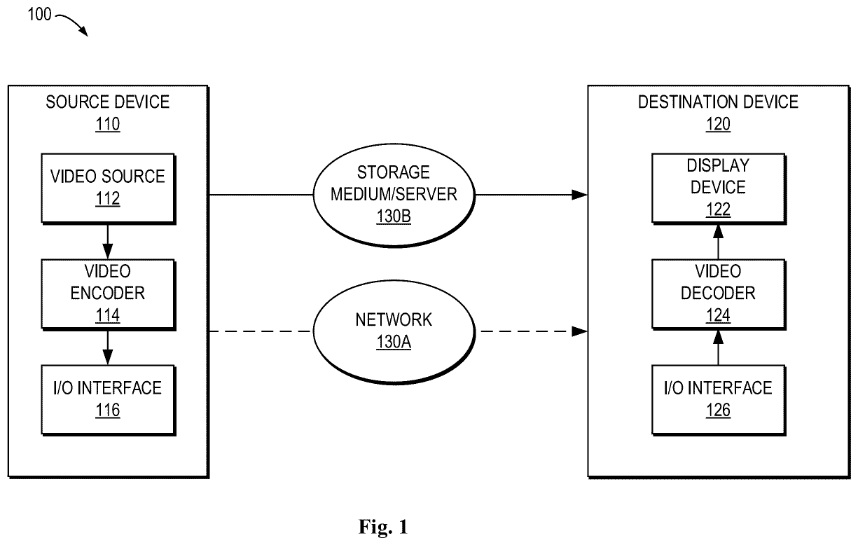

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard. Versatile Video Coding (VVC) standard and other current and/or further standards.

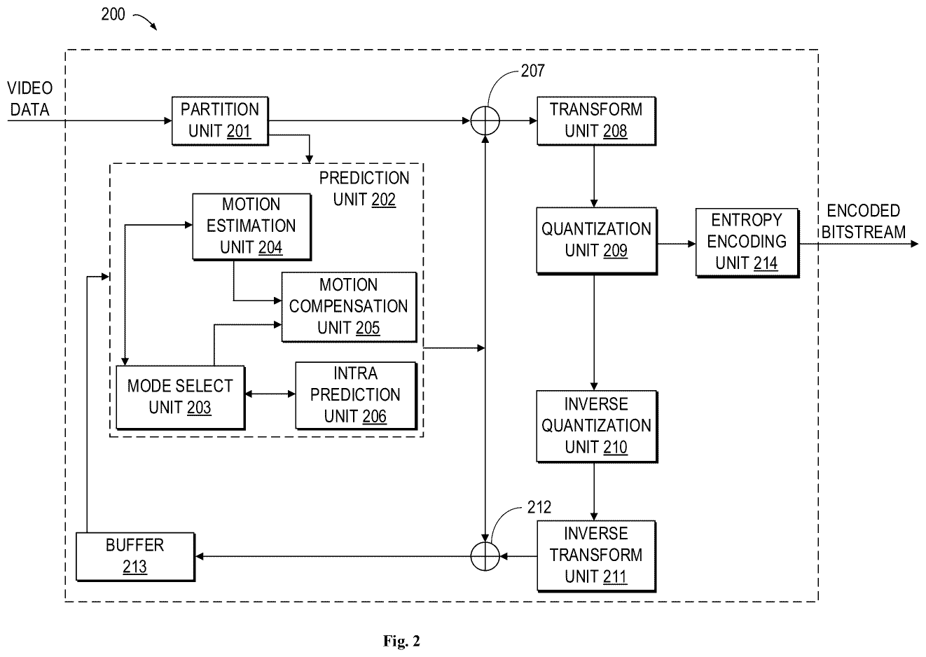

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects. “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list (and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to image/video coding, especially on adjustment of the LIC indication. It may be applied to the existing video coding standard like HEVC, or the standard VVC (Versatile Video Coding). It may be also applicable to future video coding standards or video codec.

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized.

To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

In January 2021, JVET established an Exploration Experiment (EE), targeting at enhanced compression efficiency beyond VVC capability with novel traditional algorithms. Soon later, ECM was built as the common software base for longer-term exploration work towards the next generation video coding standard.

### 2.1. Extended Merge Prediction

In VVC, the merge candidate list is constructed by including the following five types of candidates in order:
1) Spatial MVP from spatial neighbour CUs.
2) Temporal MVP from collocated CUs.
3) History-based MVP from an FIFO table.
4) Pairwise average MVP.
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.1 Spatial Candidates Derivation

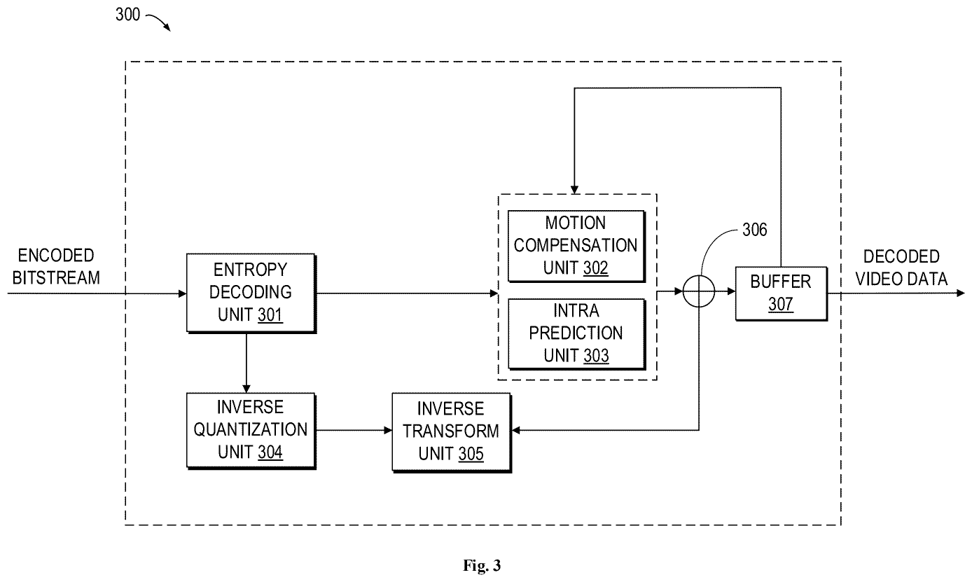

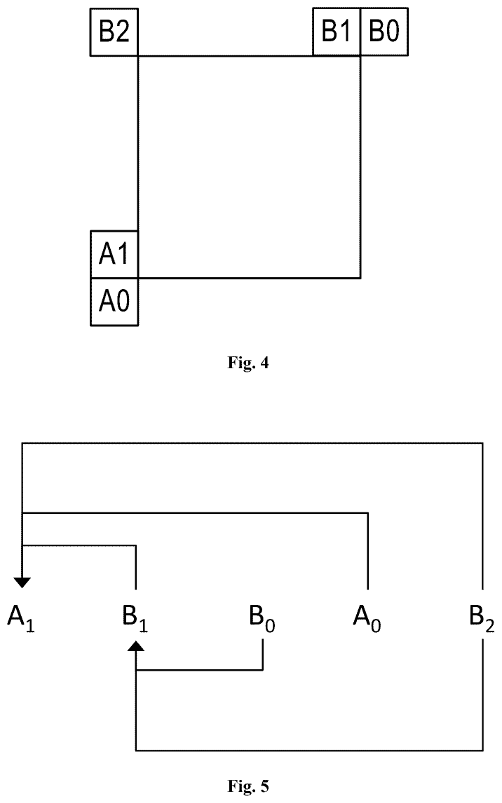

The derivation of spatial merge candidates in VVC is same to that in HEVC except the positions of first two merge candidates are swapped. A maximum of four merge candidates are selected among candidates located in the positions depicted in FIG. 4. FIG. 4 illustrates positions of spatial merge candidate. The order of derivation is B₁, A₁ B₀, A₀ and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead, only the pairs linked with an arrow in FIG. 5 are considered and a candidate is only added to the list if the corresponding candidate used for redundancy check has not the same motion information. FIG. 5 illustrates candidate pairs considered for redundancy check of spatial merge candidates.

### 2.1.2 Temporal Candidates Derivation

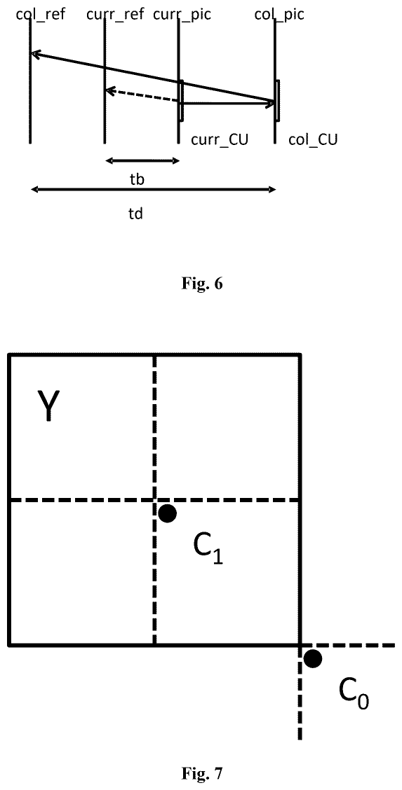

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. FIG. 6 illustrates motion vector scaling for temporal merge candidate. The scaled motion vector for temporal merge candidate is obtained as illustrated by the dotted line in FIG. 6, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 7. FIG. 7 illustrates a schematic diagram of candidate positions for temporal merge candidate, C₀ and C₁. If CU at position C₀ is not available, is intra coded, or is outside of the current row of CTUs, position C₁ is used. Otherwise, position C₀ is used in the derivation of the temporal merge candidate.

### 2.1.3 History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. The last two entries in the table are redundancy checked to A₁ and B₁ spatial candidates, respectively.
2. Once the total number of available merge candidates reaches the maximally allowed merge candidates minus 1, the merge candidate list construction process from HMVP is terminated.

### 2.1.4 Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures: if only one motion vector is available, use the one directly: if no motion vector is available, keep this list invalid.

When the merge list is not full after pair-wise average merge candidates are added, the zero MVPs are inserted in the end until the maximum merge candidate number is encountered.

### 2.2 New Merge Candidates

### 2.2.1 Non-Adjacent Merge Candidates Derivation

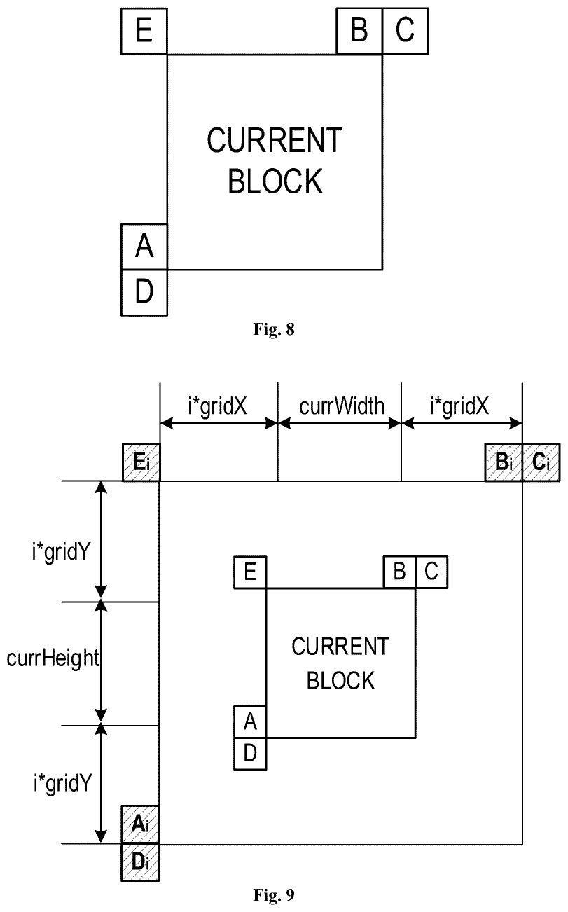

In VVC, five spatially neighboring blocks shown in FIG. 8 as well as one temporal neighbor are used to derive merge candidates. FIG. 8 illustrates a schematic diagram of VVC spatial neighboring blocks of the current block.

It is proposed to derive the additional merge candidates from the positions non-adjacent to the current block using the same pattern as that in VVC. To achieve this, for each search round i, a virtual block is generated based on the current block as follows:

First, the relative position of the virtual block to the current block is calculated by:

Offsetx=−i×gridX, Offsety=−i×gridY,
where the Offsetx and Offsety denote the offset of the top-left corner of the virtual block relative to the top-left corner of the current block, gridX and gridY are the width and height of the search grid.

Second, the width and height of the virtual block are calculated by:

newWidth=i×2×gridX+currWidth newHeight=i×2×gridY+currHeight.
where the curr Width and currHeight are the width and height of current block. The new Width and newHeight are the width and height of new virtual block.
gridX and gridY are currently set to currWidth and currHeight, respectively.

FIG. 9 illustrates the relationship between the virtual block and the current block. FIG. 9 illustrates a schematic diagram of virtual block in the ith search round.

After generating the virtual block, the blocks Aᵢ, Bᵢ, Cᵢ, Dᵢ and Eᵢ can be regarded as the VVC spatial neighboring blocks of the virtual block and their positions are obtained with the same pattern as that in VVC. Obviously, the virtual block is the current block if the search round i is 0. In this case, the blocks Aᵢ, Bᵢ, Cᵢ, Dᵢ and Eᵢ are the spatially neighboring blocks that are used in VVC merge mode.

When constructing the merge candidate list, the pruning is performed to guarantee each element in merge candidate list to be unique. The maximum search round is set to 1, which means that five non-adjacent spatial neighbor blocks are utilized.

Non-adjacent spatial merge candidates are inserted into the merge list after the temporal merge candidate in the order of B₁->A₁->C₁->D₁->E₁.

### 2.2.2 Non-Adjacent Spatial Candidate

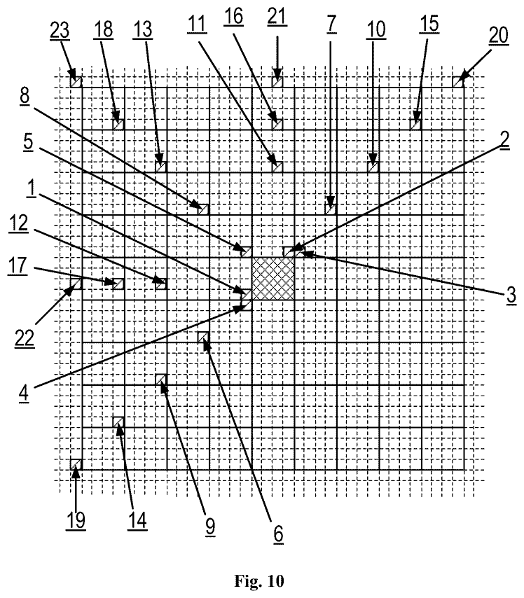

The non-adjacent spatial merge candidates are inserted after the TMVP in the regular merge candidate list. The pattern of spatial merge candidates is shown in FIG. 10. FIG. 10 illustrates spatial neighboring blocks used to derive the spatial merge candidates. The distances between non-adjacent spatial candidates and current coding block are based on the width and height of current coding block. The line buffer restriction is not applied.

### 2.2.3 Non-Adjacent Temporal Candidate

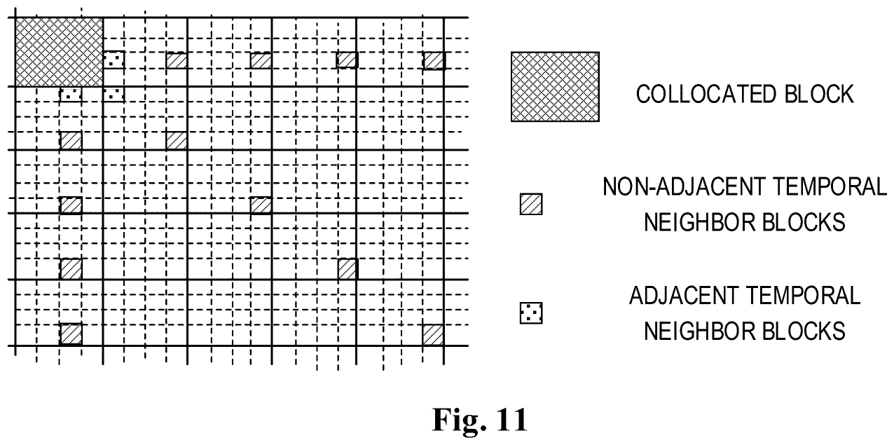

FIG. 11 illustrates non-adjacent temporal neighboring blocks used to derive the non-adjacent temporal merge candidates. The non-adjacent temporal positions are introduced as shown in FIG. 11, where non-adjacent temporal MVP positions locate in the same reference frame as the adjacent TMVP. The distances between non-adjacent temporal candidates and current coding block are based on the width and height of current coding block.

2.3. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The mmvd candidate flag is signalled to specify which one is used between the first and second merge candidates.

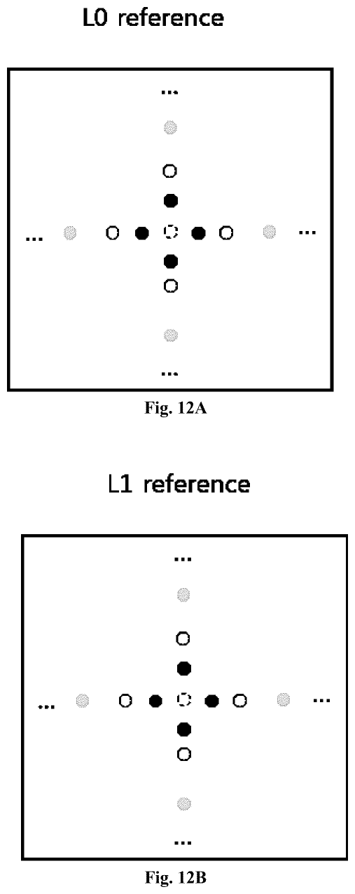

FIG. 12A and FIG. 12B illustrate MMVD search point, respectively.

Distance index specifies motion magnitude information and indicate the pre-defined offset from the starting point. As shown in FIG. 12A and FIG. 12B, an offset is added to either horizontal component or vertical component of starting MV. The relation of distance index and pre-defined offset is specified in Table 1.

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 2. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2 specifies the sign of MV offset added to the starting MV. When the starting MVs is bi-prediction MVs with the two MVs point to the different sides of the current picture (i.e, the POC of one reference is larger than the POC of the current picture, and the POC of the other reference is smaller than the POC of the current picture), and the difference of POC in list 0 is greater than the one in list 1, the sign in Table 2 specifies the sign of MV offset added to the list0 MV component of starting MV and the sign for the list1 MV has opposite value. Otherwise, if the difference of POC in list 1 is greater than list 0, the sign in Table 2 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 6. If the POC difference of L1 is greater than L0, the MVD for list 0 is scaled in the same way. If the starting MV is uni-predicted, the MVD is added to the available MV.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.4. Combined Inter and Intra Prediction (CIIP)

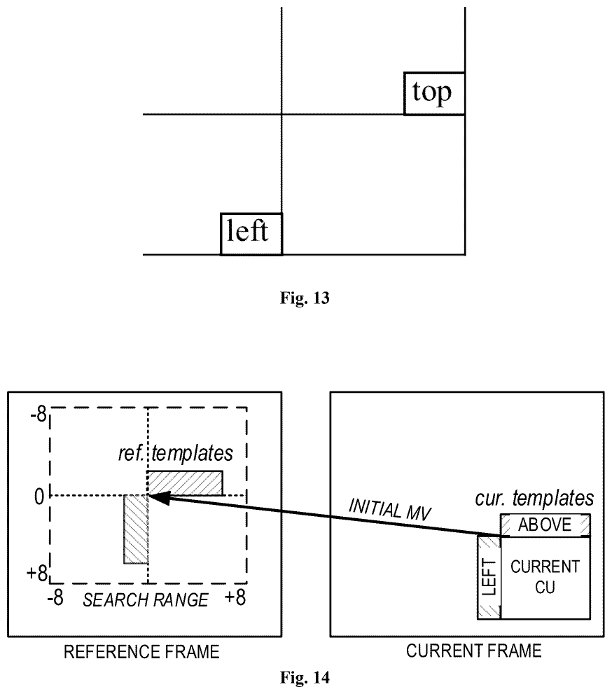

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pinter is derived using the same inter prediction process applied to regular merge mode; and the intra prediction signal Pintra is derived following the regular intra prediction process with the planar mode. Then, the intra and inter prediction signals are combined using weighted averaging, where the weight value is calculated depending on the coding modes of the top and left neighbouring blocks (depicted in FIG. 13) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2:
Otherwise, set wt to 1.

FIG. 13 illustrates top and left neighboring blocks used in CIIP weight derivation.

The CIIP prediction is formed as follows:

$${P}_{CIIP} = ( ( 4 - wt ) * {P}_{inter} + wt * {P}_{intra} + 2 ) ≫ 2.$$

### 2.5. Template Matching (TM)

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. FIG. 14 illustrates template matching performs on a search area around initial MV. As illustrated in FIG. 14, a better MV is searched around the initial motion of the current CU within a [−8, +8]-pel search range. The template matching method is used with the following modifications: search step size is determined based on AMVR mode and TM can be cascaded with bilateral matching process in merge modes.

In TM-AMVP mode, an MVP candidate is determined based on template matching error to select the one which reaches the minimum difference between the current block template and the reference block template, and then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 3. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

TABLE 3
Search patterns of AMVR and merge mode with AMVR.

| | AMVR mode | | | | | |
|---|---|---|---|---|---|---|
| Search | | Full- | Half- | Quarter- | Merge mode | |
| pattern | 4-pel | pel | pel | pel | AltIF = 0 | AltIF = 1 |
| 4-pel diamond | v | | | | | |
| 4-pel cross | v | | | | | |
| Full-pel | | v | v | v | v | v |
| diamond | | | | | | |
| Full-pel cross | | v | v | v | v | v |
| Half-pel cross | | | v | v | v | v |
| Quarter-pel | | | | v | v | |
| cross | | | | | | |
| ⅛-pel cross | | | | | v | |

In TM-merge mode, similar search method is applied to the merge candidate indicated by the merge index. As Table 3 shows, TM may perform all the way down to 1/8-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

2.6. Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

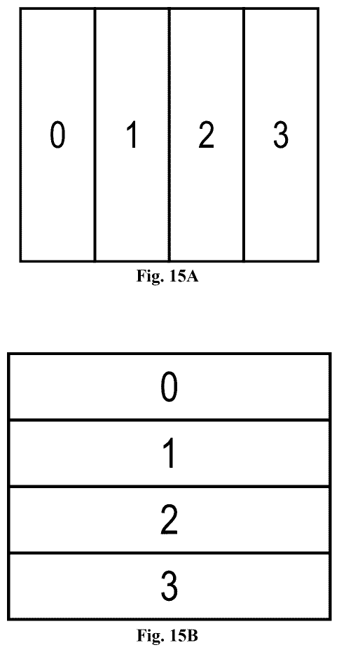

In addition, it is also proposed to modify the weights (wIntra, wInter) for the two tests if the derived intra prediction mode is an angular mode. FIG. 15A and FIG. 15B illustrate the division method for angular modes, respectively. For near-horizontal modes (2<=angular mode index<34), the current block is vertically divided as shown in FIG. 15A; for near-vertical modes (34<=angular mode index<=66), the current block is horizontally divided as shown in FIG. 15B.

The (wIntra, wInter) for different sub-blocks are shown in Table 4.

TABLE 4
The modified weights used for angular modes

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.7. Bilateral Matching AMVP-Merge Mode

The bi-directional predictor is composed of an AMVP predictor in one direction and a merge predictor in the other direction. The mode can be enabled to a coding block when the selected merge predictor and the AMVP predictor satisfy DMVR condition, where there is at least one reference picture from the past and one reference picture from the future relatively to the current picture and the distances from two reference pictures to the current picture are the same, the bilateral matching MV refinement is applied for the merge MV candidate and AMVP MVP as a starting point. Otherwise, if template matching functionality is enabled, template matching MV refinement is applied to the merge predictor or the AMVP predictor which has a higher template matching cost.

AMVP part of the mode is signaled as a regular uni-directional AMVP, i.e. reference index and MVD are signaled, and it has a derived MVP index if template matching is used or MVP index is signaled when template matching is disabled.

For AMVP direction LX, X can be 0 or 1, the merge part in the other direction (1-LX) is implicitly derived by minimizing the bilateral matching cost between the AMVP predictor and a merge predictor, i.e., for a pair of the AMVP and a merge motion vector. For every merge candidate in the merge candidate list which has that other direction (1-LX) motion vector, the bilateral matching cost is calculated using the merge candidate MV and the AMVP MV. The merge candidate with the smallest cost is selected. The bilateral matching refinement is applied to the coding block with the selected merge candidate MV and the AMVP MV as a starting point.

The third pass of multi pass DMVR which is 8×8 sub-PU BDOF refinement of the multi-pass DMVR is enabled to AMVP-merge mode coded block.

The mode is indicated by a flag, if the mode is enabled AMVP direction LX is further indicated by a flag.

When bilateral matching (BM) AMVP-merge mode is used for the current block and template matching is enabled, MVD is not signalled. An additional pair of AMVP-merge MVPs is introduced. The merge candidate list is sorted based on the BM cost in increase order. An index (0 or 1) is signaled to indicate which merge candidate in the sorted merge candidate list to use. When there is only one candidate in merge candidate list, the pair of AMVP MVP and merge MVP without bilateral matching MV refinement is padded.

### 2.8. Adaptive Decoder-Side Motion Vector Refinement

Adaptive decoder side motion vector refinement (ADMVR) method is an extension of multi-pass DMVR which consists of the two new merge modes to refine MV only in one direction, either L0 or L1, of the bi-prediction for the merge candidates that meet the DMVR conditions. The multi-pass DMVR process is applied for the selected merge candidate to refine the motion vectors, however either MVDO or MVDI is set to zero in the 1st pass (i.e., PU level) DMVR.

The merge candidates for the new merge mode are derived from spatial neighboring coded blocks, TMVPs, non-adjacent blocks, HMVPs, pair-wise candidate, similar as in the regular merge mode. The difference is that only those meet DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

### 2.9. Affine Motion Compensated Prediction

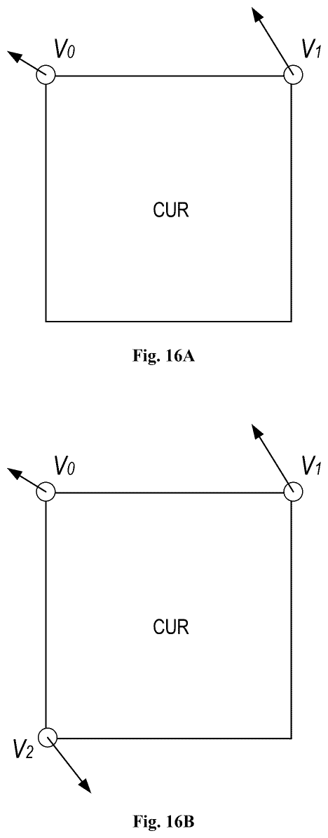

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. FIG. 16A and FIG. 16B illustrate control point based affine motion model, respectively. FIG. 16A shows a 4-parameter affine model. FIG. 16B shows a 6-parameter affine model. As shown in FIG. 16A and FIG. 16B, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix} . \qquad ( 2 - 1 )$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} . \qquad ( 2 - 2 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

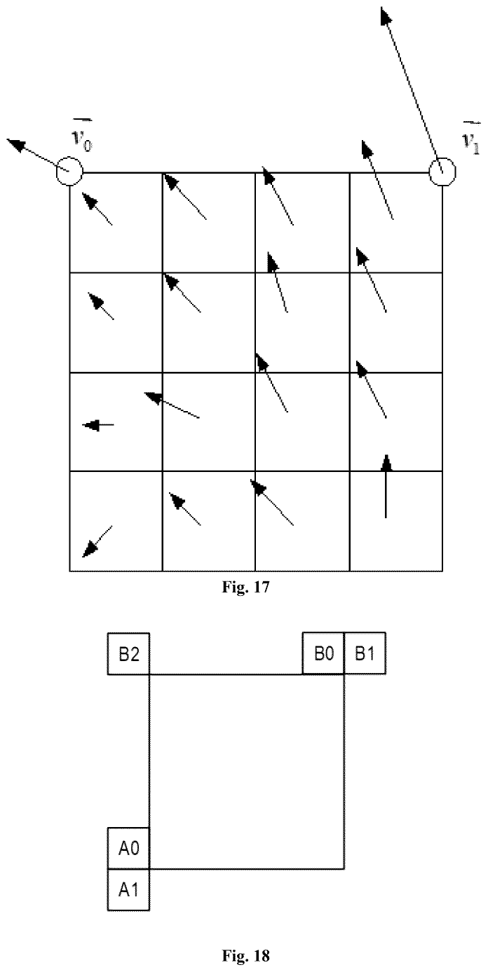

In order to simplify the motion compensation prediction, block based affine transform prediction is applied. FIG. 17 shows an affine MVF per subblock. To derive motion vector of each 4×4 luma subblock, the motion vector of the center sample of each subblock, as shown in FIG. 17, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

### 2.9.1 Affine Merge Prediction

AF_MERGE mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU. The following three types of CPMV candidate are used to form the affine merge candidate list:
Inherited affine merge candidates that extrapolated from the CPMVs of the neighbour CUs.
Constructed affine merge candidates CPMVPs that are derived using the translational MVs of the neighbour CUs.
Zero MVs.

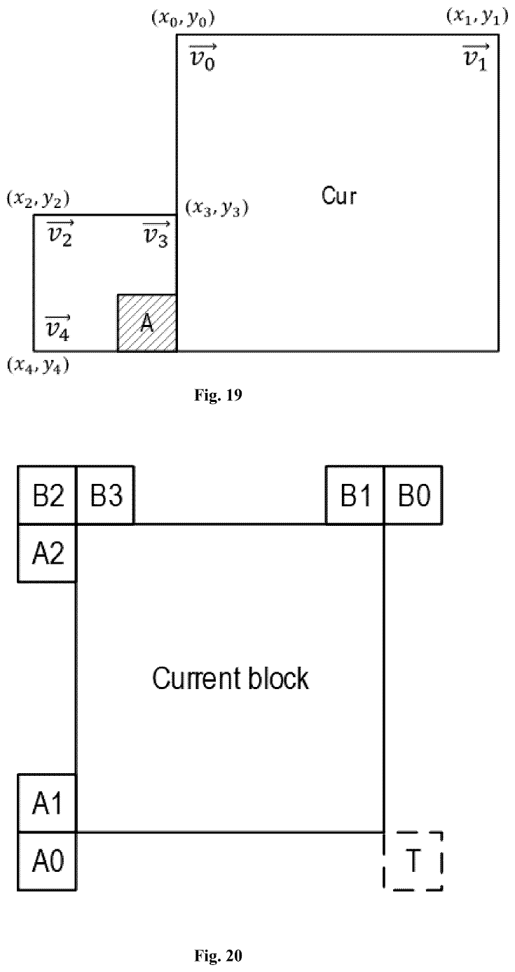

In VVC, there are maximum two inherited affine candidates, which are derived from affine motion model of the neighboring blocks, one from left neighboring CUs and one from above neighboring CUs. The candidate blocks are shown in FIG. 18. FIG. 18 illustrates locations of inherited affine motion predictors. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derived the CPMVP candidate in the affine merge list of the current CU. FIG. 19 illustrates control point motion vector inheritance. As shown in FIG. 19, if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

Constructed affine candidate means the candidate is constructed by combining the neighbor translational motion information of each control point. The motion information for the control points is derived from the specified spatial neighbors and temporal neighbor shown in FIG. 20. FIG. 20 illustrates locations of Candidates position for constructed affine merge mode. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0) blocks are checked. For TMVP is used as CPMV₄ if it's available. After MVs of four control points are attained, affine merge candidates are constructed based on those motion information. The following combinations of control point MVs are used to construct in order:
{CPMV₁, CPMV₂, CPMV₃}, {CPMV₁, CPMV₂, CPMV₄}, {CPMV₁, CPMV₃, CPMV+}, {CPMV₂, CPMV₃, CPMV₄}, {CPMV₁, CPMV₂}, {CPMV₁, CPMV₃}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### 2.9.2 History-Parameter-Based Affine Model Inheritance and Non-Adjacent Affine Mode

History-parameter-based affine model inheritance (HAMI) allows the affine model to be inherited from a previously affine-coded block which may not be neighboring to the current block. Similar to the enhanced regular merge mode, non-adjacent affine mode (NA-AFF) is introduced.

A first history-parameter table (HPT) is established. An entry of the first HPT stores a set of affine parameters: a, b, c and d, each of which is represented by a 16-bit signed integer. Entries in HPT is categorized by reference list and reference index. Five reference indices are supported for each reference list in HPT. In a formular way, the category of HPT (denoted as HPTCat) is calculated as

$$HPTCat ( RefList , RefIdx ) = 5 \times RefList + min ( RefIdx , 4 ) ,$$

wherein RefList and RefIdx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefList_{cur} and RefIdx_{cur}, the affine parameters are utilized to update entries in the category HPTCat(RefList_{cur}, Refldx_{cur}) in a way similar to HMVP table updating.

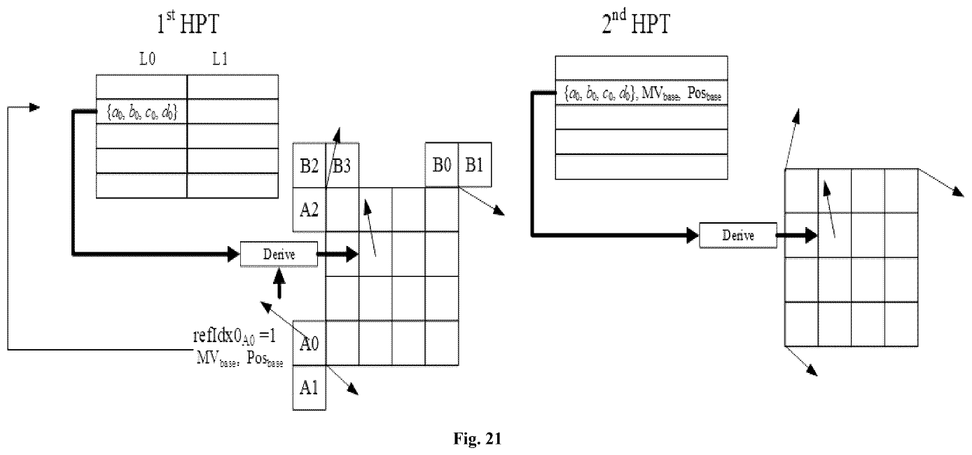

FIG. 21 illustrates first HPT and the second HPT. A history-affine-parameter-based candidate (HAPC) is derived from one of the seven neighbouring 4×4 blocks denoted as A0, A1, A2, B0, B1, B2 or B3 in FIG. 21 and a set of affine parameters stored in a corresponding entry in the first HPT. The MV of a neighbouring 4×4 block served as the base MV. In a formulating way, the MV of the current block at position (x, y) is calculated as:

$$\{ \begin{matrix}{mv}^{h} ( x , y ) = a ( x - {x}_{base} ) + c ( y - {y}_{base} ) + {mv}_{base}^{h} \\ {mv}^{v} ( x , y ) = b ( x - {x}_{base} ) + d ( y - {y}_{base} ) + {mv}_{base}^{v}\end{matrix} ,$$

where (my^{h}_{base}, my^{v}_{base}) represents the MV of the neighbouring 4×4 block, (x_{base}, y_{base}) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

A second history-parameter table (HPT) with base MV information is also appended. There are nine entries in the second HPT, wherein an entry comprises a base MV, a reference index and four affine parameters for each reference list, and a base position. An additional merge HAPC can be generated from the second HPT with the base MV information the corresponding affine models stored in an entry. The difference between the first HPT and the second HPT is illustrated in FIG. 21.

Moreover, pair-wised affine merge candidates are generated by two affine merge candidates which are history-derived or not history-derived. A pair-wised affine merge candidates is generated by averaging the CPMVs of existing affine merge candidates in the list.

As a response to new HAPCs being introduced, the size of sub-block-based merge candidate list is increased from five to fifteen, which are all involved in the ARMC process.

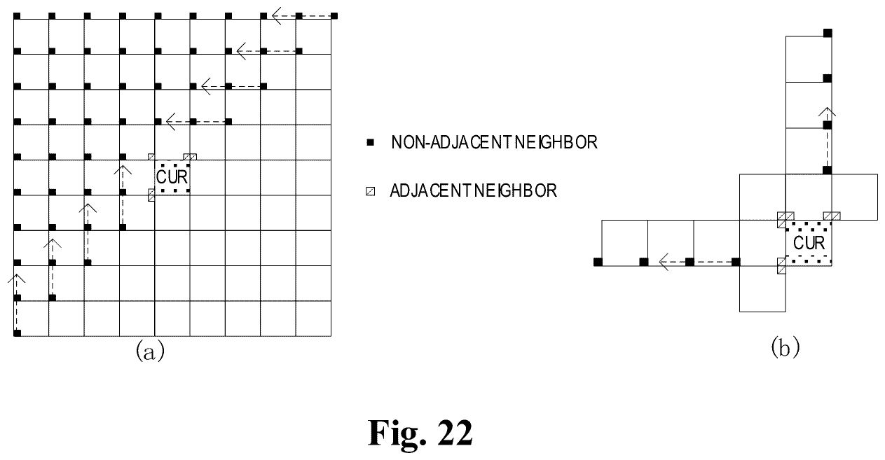

In NA-AFF, the pattern of obtaining non-adjacent spatial neighbors is shown in FIG. 22. FIG. 22 illustrates spatial neighbors for deriving affine merge/AMVP candidates: (a) for deriving inherited candidates (b) for deriving the first type of constructed candidates. Same as the existing non-adjacent regular merge candidates, the distances between non-adjacent spatial neighbors and current coding block in the NA-AFF are also defined based on the width and height of current CU.

The motion information of the non-adjacent spatial neighbors in FIG. 22 is utilized to generate additional inherited and constructed affine merge/AMVP candidates. Specifically, for inherited candidates, the same derivation process of the inherited affine merge/AMVP candidates in the VVC is kept unchanged except that the CPMVs are inherited from non-adjacent spatial neighbors. The non-adjacent spatial neighbors are checked based on their distances to the current block, i.e., from near to far. At a specific distance, only the first available neighbor (that is coded with the affine mode) from each side (e.g., the left and above) of the current block is included for inherited candidate derivation. As indicated by the dash arrows in (a) of FIG. 22, the checking orders of the neighbors on the left and above sides are bottom-to-up and right-to-left, respectively.

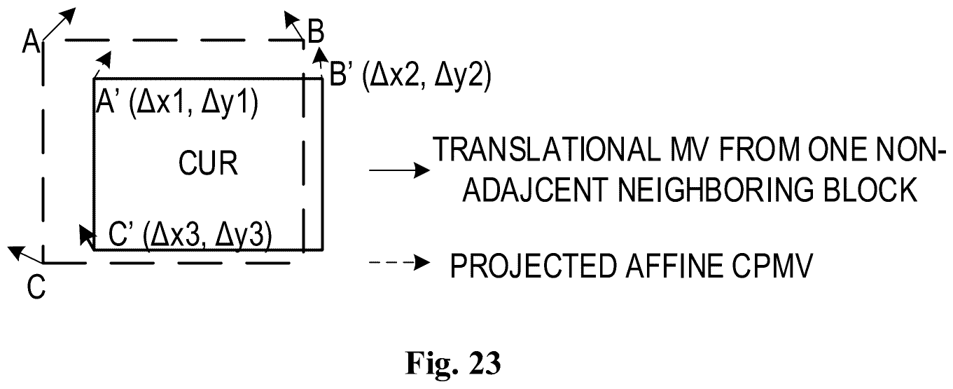

For the first type of constructed candidates, as shown in (b) of FIG. 22, the positions of one left and above non-adjacent spatial neighbors are firstly determined independently: After that, the location of the top-left neighbor can be determined accordingly which can enclose a rectangular virtual block together with the left and above non-adjacent neighbors. Then, as shown in the FIG. 23, the motion information of the three non-adjacent neighbors is used to form the CPMVs at the top-left (A), top-right (B) and bottom-left (C) of the virtual block, which is finally projected to the current CU to generate the corresponding constructed candidates. FIG. 23 illustrates from non-adjacent neighbors to the first type of constructed affine merge/AMVP candidates.

The NA-AFF candidates are inserted into the existing affine merge candidate list and affine AMVP candidate list according to the following orders:

### Affine Merge Mode:

1. SbTMVP candidate, if available.
2. Inherited from adjacent neighbors.
3. Inherited from non-adjacent neighbors.
4. Constructed from adjacent neighbors.
5. The first type of constructed affine candidates from non-adjacent neighbors.
6. Zero MVs.

### Affine AMVP Mode:

1. Inherited from adjacent neighbors.
2. Constructed from adjacent neighbors.
3. Translational MVs from adjacent neighbors.
4. Translational MVs from temporal neighbors.
5. Inherited from non-adjacent neighbors.
6. The first type of constructed affine candidates from non-adjacent neighbors.
7. Zero MVs.

Due to the inclusion of the additional candidates generated by NA-AFF, the size of the affine merge candidate list is increased from 5 to 15. The subgroup size of ARMC for the affine merge mode is increased from 3 to 15. In NA-AFF:
1. The area from where the non-adjacent neighbors come is restricted to be within the current CTU (i.e., no additional storage requirements for line buffer).
2. The storage granularity for affine motion information, including CPMVs and reference indexes, is reduced from 8×8 to 16×16 (i.e., only the affine motion from the top-left 8×8 block is saved). Additionally, the saved CPMVs are projected to each 16×16 block before storage, such that the position and size information are not needed.
3. Only the top-left and top-right CPMVs are stored (i.e., always using 4-parameter affine model for NA-AFF).

### 2.9.3 Regression Based Affine Candidate Derivation

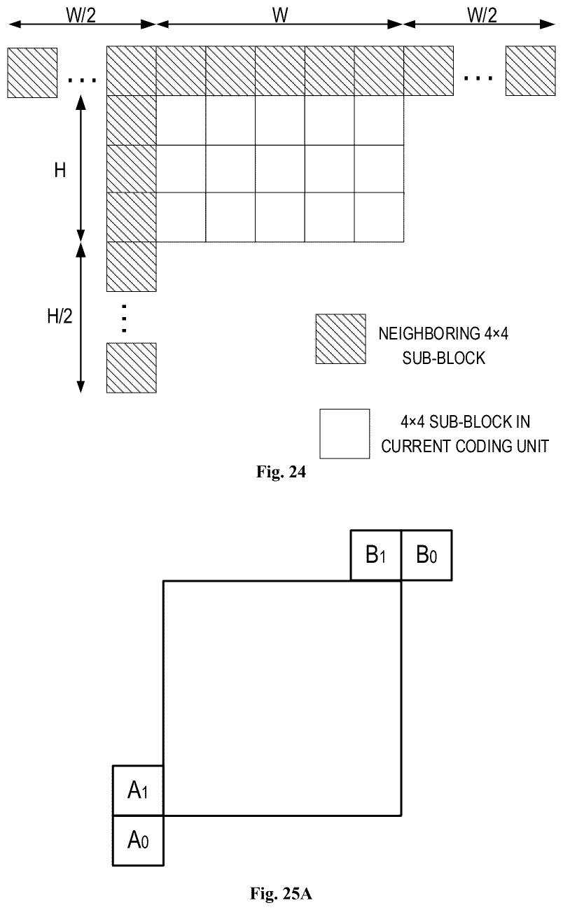

During the VVC standardization progress, the Regression based Motion Vector Field (RMVF) derivation method was proposed which provides a new variety of subblock-based merge candidate. The motion vectors and center positions from the neighboring subblocks of the current CU, as illustrated in FIG. 24, are used as the input to the linear regression process to derive a set of linear model parameters. FIG. 24 illustrates illustration of the neighboring 4×4 subblocks that are used for RMVF parameter derivation, where W and H are the width and height of the current CU.

Regression based affine candidate derivation method was proposed, the subblock motion field from a previous coded affine CU and the motion vectors from the adjacent subblocks of current CU are used as the input for the regression process. Compares to the regression process in the RMVF derivation method, the difference is that the predicted CPMVs instead of the subblock motion field for current block are derived as output. It was decided to test the proposed method in EE2.

This contribution reports the EE test results of the proposed method on top of ECM-5.0. A total of 3 tests have been performed.

In test a, the regression based affine merge candidates are derived and added to the affine merge list. Subblock motion field from a previously coded affine CU and motion information from adjacent subblocks of a current CU are used as the input to the regression process to derive proposed affine candidates.

The previously coded affine CU can be identified from scanning through non-adjacent positions and the affine HMVP table.

Adjacent subblock information of current CU is fetched from 4×4 sub-blocks represented by the grey zone as depicted in FIG. 24. For each sub-block, given a reference list, the corresponding motion vector and center coordinate of the sub-block may be used.

For each affine CU, up to 2 affine candidates can be derived. One with adjacent subblock information and one without. All the linear-regression-generated candidates are pruned and collected into one candidate sub-group, TM cost based ARMC process is applied when ARMC is enabled. Afterwards, up to N linear-regression-generated candidates are added to the affine merge list when N affine CUs are found.

In test b, the number of affine candidates for ARMC is increased from 15 to 30, the output list size is kept as 15. Finally in test c, the diversity criterion for ARMC sorting tested in EE2-2.5 are applied on top of test b.

### 2.10. Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTVMP. SbTMVP differs from TMVP in the following two main aspects:
TMVP predicts motion at CU level but SbTMVP predicts motion at sub-CU level:
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

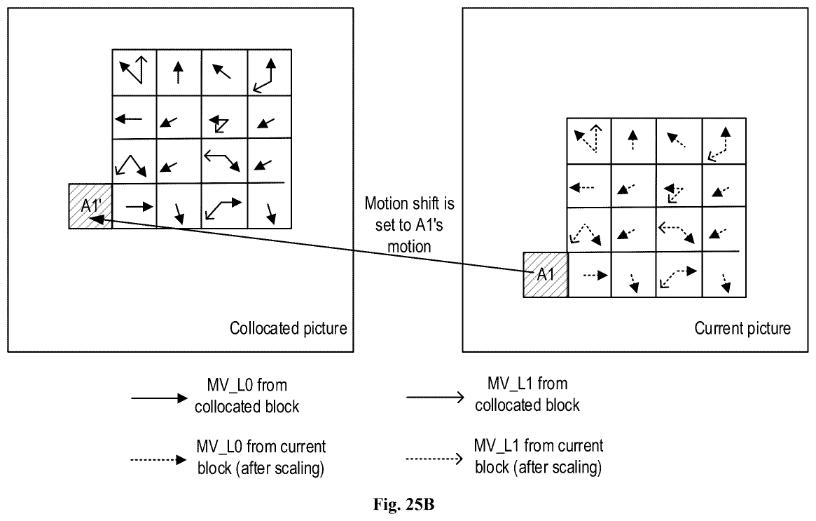

The SbTVMP process is illustrated in FIG. 25A and FIG. 25B. FIG. 25A illustrates spatial neighboring blocks used by ATMVP. FIG. 25B illustrates deriving sub-CU motion field by applying a motion shift from spatial neighbor and scaling the motion information from the corresponding collocated sub-CUs. SbTMVP predicts the motion vectors of the sub-CUs within the current CU in two steps. In the first step, the spatial neighbor A1 in FIG. 25A is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e, added to the current block's coordinates) to obtain sub-CU level motion information (motion vectors and reference indices) from the collocated picture as shown in FIG. 25B. The example in FIG. 25B assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTVMP candidate and affine merge candidates is used for the signalling of subblock based merge mode. The SbTVMP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in Por B slice, an additional RD check is performed to decide whether to use the SbTMVP candidate.

### 2.11. Affine MMVD

The affine MMVD mode that was previously proposed is adopted in this contribution. The notion of MMVD that applies a distance offset to a base candidate motion is extended to the CPMVs of affine merge mode. In Affine MMVD mode, there is only one base vector candidate which is the first affine candidate in the subblock merge candidate list, and thus there is no base vector candidate flag to be signaled. There are three sets of distance offsets to be selected based on the sequence resolution, as follows:
{ 1/16, ⅛, ¼, ½, 1} for sequences smaller than 1280×720;
{¼, ½, 1, 2, 4} for sequences smaller than 2560×1600;
{½, 1, 2, 4, 8} for sequences larger than or equal to 2560×1600.

Same as MMVD, affine MMVD also supports 4 directions (i.e., (+,0), (−,0), (0,+), (0,−)) for each of its distance offsets. When the base candidate is of uni-prediction, the offset vector (i.e., distance offset times direction) is added up equally to each CPMV. For the bi-prediction candidate, the offset vector is added up equally to L0 CPMVs, while the offset vector is firstly mirrored based on POC distance and is then added up to L1 CPMVs.

### 2.12. IBC Merge/AMVP List Construction

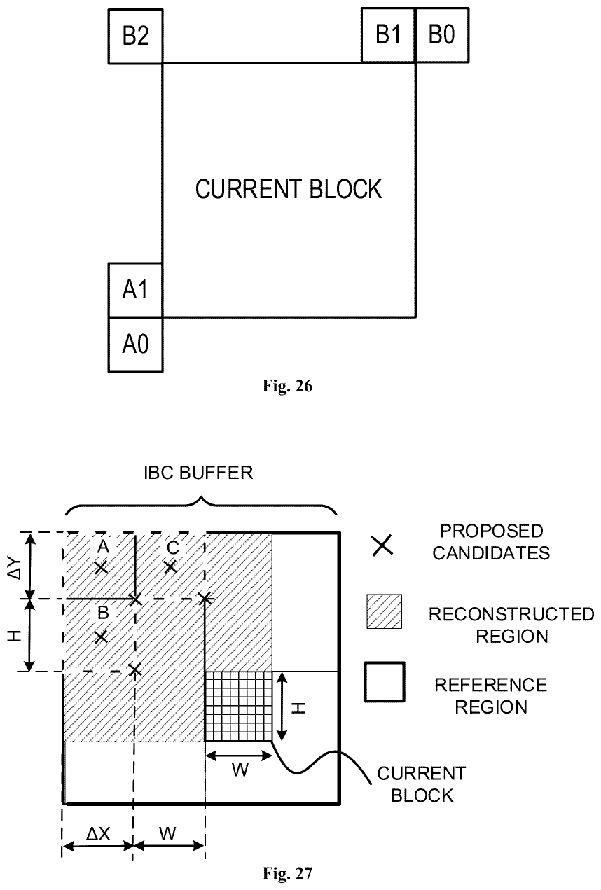

The IBC merge/AMVP list construction is modified as follows:
Only if an IBC merge/AMVP candidate is valid, it can be inserted into the IBC merge/AMVP candidate list.
Above-right, bottom-left, and above-left spatial candidates (B0, A0, and B2 as shown in FIG. 26), and one pairwise average candidate can be added into the IBC merge/AMVP candidate list. FIG. 26 illustrates spatial neighboring positions used in IBC merge/AMVP list construction.
Template based adaptive reordering (ARMC-TM) is applied to IBC merge list.

The HMVP table size for IBC is increased to 25. After up to 20 IBC merge candidates are derived with full pruning, they are reordered together. After reordering, the first 6 candidates with the lowest template matching costs are selected as the final candidates in the IBC merge list.

The zero vectors' candidates to pad the IBC Merge/AMVP list are replaced with a set of BVP candidates located in the IBC reference region. A zero vector is invalid as a block vector in IBC merge mode, and consequently, it is discarded as BVP in the IBC candidate list.

Three candidates are located on the nearest corners of the reference region, and three additional candidates are determined in the middle of the three sub-regions (A, B, and C), whose coordinates are determined by the width, and height of the current block and the ΔX and ΔY parameters, as is depicted in FIG. 27. FIG. 27 illustrates padding candidates for the replacement of the zero-vector in the IBC list.

2.13. IBC with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0,−H) and top-left (−W,−H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

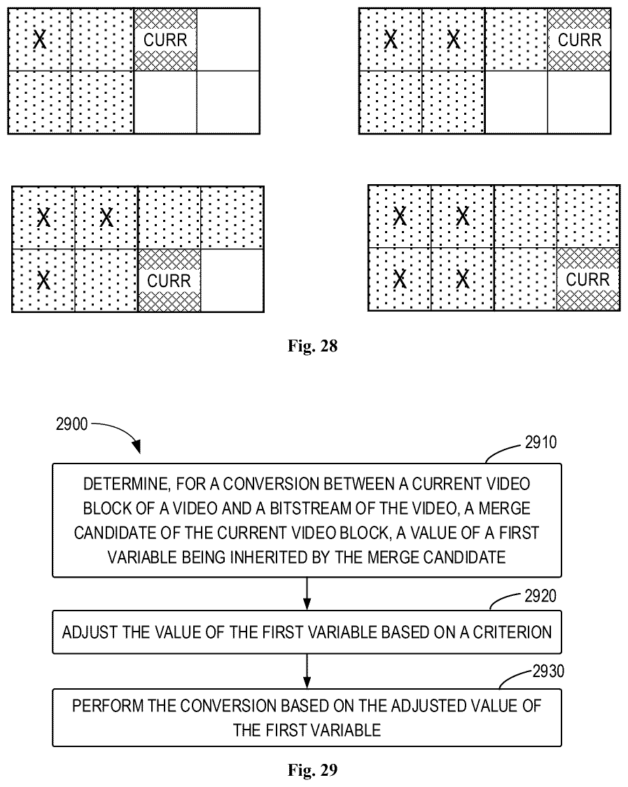

The Template Matching refinement for both IBC-TM merge and AMVP modes is quite simple since IBC motion vectors are constrained (i) to be integer and (ii) within a reference region as shown in FIG. 28. FIG. 28 illustrates IBC reference region depending on current CU position. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

2.14. IBC Merge Mode with Block Vector Differences (IBC-MBVD)

Affine-MMVD and GPM-MMVD have been adopted to ECM as an extension of regular MMVD mode. It is natural to extend the MMVD mode to the IBC merge mode.

In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the rice code with the parameter equal to 1.

An IBC-MBVD coded block does not inherit flip type from a RR-IBC coded neighbor block.

### 2.15. Local Illumination Compensation (LIC)

LIC is an inter prediction technique to model local illumination variation between current block and its prediction block as a function of that between current block template and reference block template. The parameters of the function can be denoted by a scale α and an offset β, which forms a linear equation, that is, α*p[x]+β to compensate illumination changes, where p[x] is a reference sample pointed to by MV at a location x on reference picture. When wrap around motion compensation is enabled, the MV shall be clipped with wrap around offset taken into consideration. Since α and β can be derived based on current block template and reference block template, no signaling overhead is required for them, except that an LIC flag is signaled for AMVP mode to indicate the use of LIC.

The local illumination compensation is used for uni-prediction inter CUs with the following modifications.
Intra neighbor samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

### 2.16. Improvements on Local Illumination Compensation

### 2.16.1 Bi-Predictive LIC

In the method, the LIC mode is extended to bi-predictive CUs. Specifically, two different linear models are applied to the two prediction blocks which are then combined to generate the bi-prediction samples of the current CU, i.e.,

$${P}^{′} [ x , y ] = ( 1 - ω ) \cdot {p}_{0}^{′} [ x , y ] + ω \cdot {p}_{1}^{′} [ x , y ] and$$

$${p}_{0}^{′} [ x , y ] = {α}_{0} \cdot {P}_{0} [ x , y ] + {β}_{0}$$

$${p}_{1}^{′} [ x , y ] = {α}_{1} \cdot {P}_{1} [ x , y ] + {β}_{1}$$

where α₀ and β₀, and α₁ and β₁ indicate the scales and the offsets in L0 and L1, respectively: ω indicates the weight (as indicated by the CU-level BCW index) for the weighted combination of L0 and L1 predictions. The same derivation scheme of the LIC mode is reused and applied in one iterative manner to derive the L0 and L1 LIC parameters. Specifically, the method firstly derives the L0 parameters by minimizing difference between L0 template prediction T₀ and the template T and the samples in T are updated by subtracting the corresponding samples in T₀. Then, the L1 parameters are calculated that minimizes the difference between L1 template prediction T₁ and the updated template. Finally, the L0 parameter is refined again in the same way.

Following the current LIC design, one flag is signaled for AMVP bi-predicted CUs for the indication of the LIC mode while the flag is inherited for merge related inter CUs. Additionally, the LIC is disabled when decoder-side motion vector refinement (DMVR) (including multi-pass DMVR, adaptive DMVR and affine DMVR) and bi-directional optical flow (BDOF) is applied.

2.16.2 OBMC with LIC

In the method, the OBMC is enabled for the inter blocks that are coded with the LIC mode. And, to reduce the complexity, the OBMC is only applied to the top and left CU boundaries while being always disabled for the boundaries of the internal sub-blocks of one LIC CU. Additionally, when one neighboring block is coded with the LIC, its LIC parameters are applied to generate the corresponding prediction samples for the OBMC of one current block.

2.17. IBC with Local Illumination Compensation (IBC-LIC)

Intra block copy with local illumination compensation (IBC-LIC) is a coding tool which compensates the local illumination variation within a picture between the CU coded with IBC and its prediction block with a linear equation. The parameters of the linear equation are derived same as LIC for inter prediction except that the reference template is generated using block vector in IBC-LIC. IBC-LIC can be applied to IBC AMVP mode and IBC merge mode. For IBC AMVP mode, an IBC-LIC flag is signalled to indicate the use of IBC-LIC. For IBC merge mode, the IBC-LIC flag is inferred from the merge candidate.

### 2.18. Improvement Over IBC-LIC

It is proposed to add three more modes for IBC-LIC to further improve the coding performance.

The first two modes are related to using different template shapes in the parameters' derivation. In the current ECM, IBC-LIC uses both the top and left templates to derive the parameters. It is proposed to allow IBC-LIC to use the top-only, left-only, or top and left templates for deriving the model parameters.

In addition, it is proposed to extend the MMLM to IBC-LIC, which allows IBC-LIC to have two linear models in one CU.

Finally, it is proposed to remove the large block-size constraint for IBC-LIC. In this contribution, IBC-LIC and the proposed additional modes can be applied to the CU whose block size is larger than 32.

In the AMVP mode, the signalling of the proposed method is summarized in Table 5.

TABLE 5
IBC-LIC signalling in the proposed method

| Value | Mode |
|---|---|
| 0 | Not IBC-LIC |
| 100 | Default IBC-LIC |
| 101 | Multi-models IBC-LIC |
| 110 | Top-only IBC-LIC |
| 111 | Left-only IBC-LIC |

### 3. PROBLEMS

For inter merge/affine merge/IBC merge mode, the inter-LIC flag/affine-LIC flag/IBC-LIC flag is inherited from the merge candidate. It may be not so accurate.

### 4. DETAILED SOLUTIONS

The detailed embodiments below should be considered as examples to explain general concepts. These embodiments should not be interpreted in a narrow way. Furthermore, these embodiments can be combined in any manner.

In the following, the inter merge mode may include but not limited to at least one of regular merge mode, MMVD mode, CIIP mode, TM-merge mode, CIIP-TM merge mode, ADMVR merge mode, bilateral matching AMVP-merge mode: the affine merge mode may include but not limited to at least one of affine merge mode, affine-TM merge mode, affine MMVD mode: the IBC merge mode may include but not limited to at least one of IBC merge mode, IBC-TM merge mode, IBC-MBVD mode.

In the following, the merge candidate can be in any of the above listed merge mode.
1. In one example, a first variable inherited by a merge candidate may be adjusted according to a criterion.
   a. In one example, the first variable may be a LIC flag.
   b. In one example, the first variable may be a LIC index (e.g., IBC-LIC indication signalled in section 2.18).
   c. In one example, the criterion may be based on a template of the current block (current template) and/or a template of the reference block (the reference template).
      (a) In one example, the criterion may be template matching cost.
      i. In one example, the cost function between current template and reference template may be SAD/MR-SAD, SATD/MR-SATD, SSD/MR-SSD, SSE/MR-SSE, Weighted SAD/weighted MR-SAD, Weighted SATD/weighted MR-SATD, Weighted SSD/weighted MR-SSD, Weighted SSE/weighted MR-SSE.
   d. In one example, the first variable such as the LIC flag of a merge candidate may be derived by comparing template matching costs with the first variable such as the LIC flag to be true (i.e., LIC on) or false (i.e., LIC off). The template cost corresponding to LIC flag to be false is denoted as tmCost0 and the template cost corresponding to LIC flag to be true is denoted as tmCost1.
      (a) In one example, the reference template may not perform LIC operation, for LIC on, MRSAD is used as the template matching cost; for LIC off, SAD is used as the template matching cost.
      (b) In one example, for both LIC on and LIC off, SAD is used as the template matching cost. And for LIC on, the reference template may need to perform LIC operation.
         1) In one example, the above template and left template may share one group of LIC parameters.
         2) In one example, the above template has one group of LIC parameters and the left template has the other group of LIC parameters.
      (c) In one example, the template matching cost may be modified.
         1) In one example, the template matching cost (e.g., tmCost) may be multiplied by a factor.
         i. In one example, the template matching cost of the inherited LIC flag (e.g., tmCostInherited) may be multiplied by a factor (i.e., tmCostInheritedFactor).
         (i) In one example, the factor may be smaller than one.
         (ii) In one example, the factor may be ¾, ½, ¼, or ⅛.
         (iii) In one example, at least a multiplication and a shift may be used to apply the factor.
         a) In one example, tmCost′=(tmCost*F+Offset)>>S, where tmCost′ is the template cost after the factor multiplication, F, Offset and S are integers, tmCost′ is the template cost after the modification.
         a. In one example, Offset=1<<(S−1).
         b. In one example, tmCostInheritedFactor may be defined as (F+Offset)>>S.
         ii. In one example, the factor (e.g., tmCostInheritedFactor) may be different for different picture types.
         (i) In one example, the picture types may be low delay and non-low delay pictures.
         (ii) In one example, the picture types may depend on whether backward inter-prediction is applied for a picture.
         a) In one example, the backward inter-prediction may refer to one current picture has a reference picture whose POC is larger than POC of the current picture.
         b) In one example, a picture with backward inter-prediction may be defined as a non-low delay picture.
         c) In one example, a picture without backward inter-prediction may be defined as a low delay picture.
         (iii) In one example, for an uni-prediction merge candidate of inter merge mode, for non-low delay pictures, the template matching cost of the inherited LIC flag may be multiplied by a factor of ½; for low delay pictures, the template matching cost of the inherited LIC flag may be multiplied by a factor of ¾.
         (iv) Alternatively, the factor (e.g., tmCostInheritedFactor) may be the same for different picture types.
         iii. In one example, the factor (e.g., tmCostInheritedFactor) may be different for different prediction directions of merge candidates.
         (i) In one example, the factor (e.g., tmCostInheritedFactor) may be different for an uni-prediction merge candidate and a bi-prediction merge candidate.
         (ii) In one example, the factor (e.g., tmCostInheritedFactor) of a bi-prediction merge candidate may be smaller than the factor (e.g., tmCostInheritedFactor) of an uni-prediction merge candidate.
         (iii) In one example, the factor (e.g., tmCostInheritedFactor) of a bi-prediction merge candidate may be ¼; the factor (e.g., tmCostInheritedFactor) of an uni-prediction merge candidate may be ½.
         (iv) Alternatively, the factor (e.g., tmCostInheritedFactor) may be the same for different prediction directions.
         iv. In one example, the factor (e.g., tmCostInheritedFactor) may be different for different merge modes.
         (i) In one example, the factor (e.g., tmCostInheritedFactor) may be different for inter merge/affine merge/IBC merge modes.
         (ii) In one example, the factor (e.g., tmCostInheritedFactor) may be different for at least two of regular merge mode, MMVD mode, CIIP mode, TM-merge mode, CIIP-TM merge mode, ADMVR merge mode, bilateral matching AMVP-merge mode.
         (iii) In one example, the factor (e.g., tmCostInheritedFactor) may be different for at least two of affine merge mode, affine-TM merge mode, affine MMVD mode.
         (iv) In one example, the factor (e.g., tmCostInheritedFactor) may be different for at least two of IBC merge mode, IBC-TM merge mode, IBC-MBVD mode.
         (v) Alternatively, the factor (e.g., tmCostInheritedFactor) may be the same for different merge modes.
         v. In one example, the factor (e.g., tmCostInheritedFactor) may be different for different inherited LIC flags.
         (i) In one example, the tmCostInheritedFactor of the inherited LIC flag of true may be larger than the tmCostInheritedFactor of the inherited LIC flag of false.
         (ii) Alternatively, the factor (e.g., tmCostInheritedFactor) may be the same for different inherited LIC flags.
         vi. In one example, the factor (e.g., tmCostInheritedFactor) may be different for different sequence resolutions.
         (i) Alternatively, the factor (e.g., tmCostInheritedFactor) may be the same for different sequence resolutions.
         vii. In one example, the factor (e.g., tmCostInheritedFactor) may be different for different slice types.
         (i) Alternatively, the factor (e.g., tmCostInheritedFactor) may be the same for different slice types.
         viii. In one example, the factor (e.g., tmCostInheritedFactor) may be different for different coding configurations.
         (i) Alternatively, the factor (e.g., tmCostInheritedFactor) may be the same for different coding configurations.
         2) In one example, the modified tmCostInherited denoted as tmCostInherited′ may be derived as f(tmCostInherited), where f is a function.
         i. tmCostInherited′=tmCostInherited−RightShift(tmCostInherited, 4)−RightShift(tmCostInherited, 5).
         ii. tmCostInherited′=tmCostInherited−RightShift(tmCostInherited, 3)−RightShift(tmCostInherited, 4).
         iii. tmCostInherited′=tmCostInherited−RightShift(tmCostInherited, 2), in this case, the tmCostInheritedFactor can be treated as ¾.
         iv. tmCostInherited′=tmCostInherited−RightShift(tmCostInherited, 1), in this case, the tmCostInheritedFactor can be treated as ½.
         v. tmCostInherited′=RightShift(tmCostInherited, 1).
         vi. tmCostInherited′=RightShift(tmCostInherited, 2).
         vii. tmCostInherited′=RightShift(tmCostInherited, 3).
         viii. In one example, RightShift(X, S)=(X+offset)>>S, where offset is an integer, e.g. offset=1<<(S-1).
      (d) Whether and/or how to modify the template matching cost may depend on the inherited LIC flag.
         1) For example, if the inherited LIC flag of a merge candidate is false, then tmCost0 is modified as tmCost0′=tmCost0*tmCostInheritedFactor with tmCostInheritedFactor<M. M is an integer such as 1.
         2) For example, if the inherited LIC flag of a merge candidate is false, then tmCost1 is modified as tmCost1′=tmCost1*tmCostInheritedFactor with tmCostInheritedFactor>M. M is an integer such as 1.
         3) For example, if the inherited LIC flag of a merge candidate is true, then tmCost0 is modified as tmCost0′=tmCost0*tmCostInheritedFactor with tmCostInheritedFactor>M. M is an integer such as 1.
         4) For example, if the inherited LIC flag of a merge candidate is true, then tmCost1 is modified as tmCost1′=tmCost1*tmCostInheritedFactor with tmCostInheritedFactor<M. M is an integer such as 1.
      (e) In one example, if the inherited LIC flag of a merge candidate is false, the LIC flag of a merge candidate may be derived by comparing template matching costs with LIC on and LIC off; if the inherited LIC flag of a merge candidate is true, the LIC flag of a merge candidate may be set to its inherited LIC flag.
         1) Alternatively, if the inherited LIC flag of a merge candidate is true, the LIC flag of a merge candidate may be derived by comparing template matching cost with LIC on and LIC off; if the inherited LIC flag of a merge candidate is false, the LIC flag of a merge candidate may be set to its inherited LIC flag.
2. In one example, the LIC flag of a merge candidate may be adjusted in a predefined step.
   a. In one example, the LIC flag of a merge candidate may be adjusted directly after constructing the merge candidate list.
   b. In one example, the LIC flag of a merge candidate may be adjusted directly after reordering the merge candidate list if the merge candidate list has reordering operation.
   c. In one example, the LIC flag of a merge candidate may be adjusted directly after the adjustment of the BCW index of a merge candidate if the merge candidate is bi-predicted.
   d. In one example, the LIC flag of a merge candidate may be adjusted before the DMVR/multi-pass DMVR process if it has.
      (a) Alternatively, the LIC flag of a merge candidate may be adjusted after the DMVR/multi-pass DMVR process if it has.
   e. In one example, the LIC flag of a TM-merge candidate may be adjusted before template matching refinement process of the TM-merge candidate.
      (a) Alternatively, the LIC flag of a TM-merge candidate may be adjusted after template matching refinement process of the TM-merge candidate.
   f. In one example, the LIC flag of an IBC-TM merge candidate may be adjusted before template matching refinement process of the IBC-TM merge candidate.
      (a) Alternatively, the LIC flag of an IBC-TM merge candidate may be adjusted after template matching refinement process of the IBC-TM merge candidate.
   g. In one example, at both encoder and decoder, the LIC flags of all the merge candidates may be adjusted.
   h. In one example, at encoder, the LIC flags of all the merge candidates may be adjusted; at decoder, only the LIC flag of the selected merge candidate corresponding to the signaled merge candidate index may be adjusted.
3. In one example, whether to adjust the LIC flag of a merge candidate may be predefined.
   a. Alternatively, whether to adjust the LIC flag of a merge candidate may be signalled.
4. In one example, the methods presented in the above bullets may be applied to other LIC indications.
   a. In one example, the LIC indication may be LIC flag, LIC index, or other LIC indication form.

### General Information

5. A syntax element disclosed above may be binarized as a flag, a fixed length code, an EG(x) code, a unary code, a truncated unary code, a truncated binary code, etc. It can be signed or unsigned.
6. A syntax element disclosed above may be coded with at least one context model. Or it may be bypass coded.
7. A syntax element (SE) disclosed above may be signaled in a conditional way.
   a. The SE is signaled only if the corresponding function is applicable.
8. A syntax element disclosed above may be signaled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
9. In above examples, the block may refer to the colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.
10. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
11. Whether to and/or how to apply the disclosed methods above may be signalled at PB/TB/CB/PU/TU/CU/VPDU/CTU/CTU row/slice/tile/sub-picture/other kinds of region contains more than one sample or pixel.
12. Whether to and/or how to apply the disclosed methods above may be dependent on coded information, such as block size, colour format, single/dual tree partitioning, colour component, slice/picture type.

Further embodiments will be described below. FIG. 29 illustrates a flowchart of a method 2900 for video processing in accordance with embodiments of the present disclosure. The method 2900 is implemented during a conversion between a video unit or video block of a video and a bitstream of the video.

At block 2910, for a conversion between a current video block of a video and a bitstream of the video, a merge candidate of the current video block is determined. A value of a first variable is inherited by the merge candidate.

At block 2920, the value of the first variable is adjusted based on a criterion.

At block 2930, the conversion is performed based on the adjusted value of the first variable. In some embodiments, the conversion may include encoding the current video block into the bitstream. Alternatively, or in addition, the conversion may include decoding the current video block from the bitstream.

The method 2900 enables adjusting the inherited variable according to a criterion. The coding effectiveness and/or coding efficiency can thus be improved.

In some embodiments, the first variable comprises a parameter associated with a local illumination compensation (LIC). By way of example, the parameter associated with LIC comprises at least one of: an LIC flag, an LIC index, an LIC indication, or an intra block copy (IBC) with LIC (IBC-LIC) indication.

In some embodiments, adjusting the value of the first variable based on the criterion comprises: determining a first template matching cost based on a first metric: determining a second template matching cost based on a second metric; and adjusting the value of first variable based on a comparison of the first and second template matching costs. For example, the first metric may be SAD, and the second metric may be MR-SAD. That is, LIC flag of a merge candidate may be derived by comparing two template costs: a SAD-based template cost, denoted as C0, and a Mean Removal SAD (MRSAD)-based template cost, denoted as C1.

In some embodiments, the first variable comprises a local illumination compensation (LIC) flag, and adjusting the value of the first variable based on the comparison comprises: in accordance with a determination that the first template matching cost is less than or equal to the second template matching cost, determining the value of the LIC flag as false, and in accordance with a determination that the first template matching cost is greater than the second template matching cost, determining the value of the LIC flag as true. That is, the LIC flag is set to be false, if C0<=C₁. The LIC flag is set to be true, if C0>C1.

In some embodiments, an LIC operation is not performed for a reference template, the first template matching cost is determined with the LIC flag being false, and the second template matching cost is determined with the LIC flag being true.

In some embodiments, at least one of the first template matching cost or the second template matching cost is modified by multiplying a factor.

In some embodiments, if the value of the inherited LIC flag is false, the first template matching cost is modified by multiplying the factor. Alternatively, or in addition, in some embodiments, if the value of the inherited LIC flag is true, the second template matching cost is modified by multiplying the factor. In other words, C0 is multiplied by α if the inherited LIC flag is false while C1 is multiplied by a if the inherited LIC flag is true, where α<1.

In some embodiments, the first variable comprises an inherited local illumination compensation (LIC) flag, and a template matching cost of the inherited LIC flag is modified by a factor.

In some embodiments, the factor is smaller than a threshold value, the threshold value comprising 1.

In some embodiments, the factor comprises one of: ¾, ½, ¼, or ⅛.

In some embodiments, the template matching cost is modified by at least a multiplication based on the factor and a shift operation.

In some embodiments, the template matching cost is modified by: tmCost′=(tmCost*F+Offset)>>S, where tmCost denotes the template matching cost, tmCost′ denotes the modified template matching cost, F, Offset and S are integers.

In some embodiments, Offset=1<<(S−1).

In some embodiments, the factor is determined as (F+Offset)>>S.

In some embodiments, the factor is different for a plurality of picture types, the plurality of picture types comprising a low delay picture type and a non-low delay picture type.

In some embodiments, a picture type of a current picture containing the current video block is based on whether a backward inter-prediction is applied for the current picture.

In some embodiments, the backward inter-prediction refers to the current picture having a reference picture, a picture of order count of the reference picture being larger than a picture of order count of the current picture.

In some embodiments, the current picture with the backward inter-prediction is a non-low delay picture.

In some embodiments, the current picture without the backward inter-prediction is a low delay picture.

In some embodiments, for a uni-prediction merge candidate of inter merge mode, the template matching cost is modified by the factor of ½ for a non-low delay picture, and the template matching cost is modified by the factor of ¾ for a low delay picture.

In some embodiments, the factor is the same for different picture types.

In some embodiments, the factor is different for different prediction directions of merge candidates.

In some embodiments, a first factor for a uni-prediction merge candidate is different from a second factor for a bi-prediction merge candidate, the first and second factors being used for modifying corresponding template matching costs.

In some embodiments, the second factor is smaller than the first factor.

In some embodiments, the second factor is ¼, and the first factor is ½.

In some embodiments, the factor is the same for different prediction directions.

In some embodiments, the factor is different for different merge modes.

In some embodiments, a first factor for inter merge mode is different from a second factor for affine merge mode, and the first or second factor is different from a third factor for an intra block copy (IBC) merge mode, the first, second and third factor being used for modifying corresponding template matching costs.

In some embodiments, factors for modifying template matching costs are different for at least two of: a regular merge mode, a merge mode with motion vector differences (MMVD) mode, a combined inter and intra prediction (CIIP) mode, a template matching (TM)-merge mode, a CIIP with TM (CIIP-TM) merge mode, an adaptive decoder-side motion vector refinement (ADMVR) merge mode, or a bilateral matching advanced motion vector prediction (AMVP) merge mode.

In some embodiments, factors for modifying template matching costs are different for at least two of: an affine merge mode, an affine template matching (TM) merge mode, or an affine merge mode with motion vector differences (MMVD) mode.

In some embodiments, factors for modifying template matching costs are different for at least two of: an intra block copy (IBC) merge mode, an IBC with template matching (TM) (IBC-TM) merge mode, or an IBC merge mode with block vector differences (IBC-MBVD) mode.

In some embodiments, the factor is the same for different merge modes.

In some embodiments, the factor is different for different inherited LIC flags.

In some embodiments, the factor of the inherited LIC flag being tree is larger than the factor of the inherited LIC flag being false.

In some embodiments, the factor is the same for different inherited LIC flags.

In some embodiments, the factor is different for different sequence resolutions.

In some embodiments, the factor is the same for different sequence resolutions.

In some embodiments, the factor is different for different slice types.

In some embodiments, the factor is the same for different slice types.

In some embodiments, the factor is different for different coding configurations.

In some embodiments, the factor is the same for different coding configurations.

In some embodiments, the template matching cost of the inherited LIC flag is modified by one of: tmCostInherited′=tmCostInherited−RightShift(tmCostInherited, 4)−RightShift(tmCostInherited, 5), tmCostInherited′=tmCostInherited−RightShift(tmCostInherited, 3)−RightShift(tmCostInherited, 4), tmCostInherited′=tmCostInherited-RightShift(tmCostInherited, 2), tmCostInherited′=tmCostInherited−RightShift(tmCostInherited, 1), tmCostInherited′=RightShift(tmCostInherited, 1), tmCostInherited′=RightShift(tmCostInherited, 2), or tmCostInherited′=RightShift(tmCostInherited, 3), where tmCostInherited denotes the template matching cost of the inherited LIC flag, tmCostInherited′ denotes the modified template matching cost, RightShift denotes a shifting operation.

In some embodiments, the shifting operation comprises RightShift(X, S)=(X+offset)>>S, where offset is an integer, offset=1<<(S−1), S being a parameter.

In some embodiments, the template matching cost of the inherited LIC flag is modified by tmCostInherited′=tmCostInherited−RightShift(tmCostInherited, 2), the factor for modifying the template matching cost being ¾. In some embodiments, the template matching cost of the inherited LIC flag is modified by tmCostInherited=tmCostInherited−RightShift(tmCostInherited, 1), the factor for modifying the template matching cost being ½.

In some embodiments, whether to and/or how to modify the template matching cost is based on a value of the inherited LIC flag.

In some embodiments, the value of the inherited LIC flag of a merge candidate is false, and a first template matching cost with LIC flag being false is modified by multiplying a factor, the factor being less than a predetermined integer.

In some embodiments, the value of the inherited LIC flag of a merge candidate is false, and a second template matching cost with LIC flag being true is modified by multiplying a factor, the factor being larger than a predetermined integer.

In some embodiments, the value of the inherited LIC flag of a merge candidate is true, and a first template matching cost with LIC flag being false is modified by multiplying a factor, the factor being larger than a predetermined integer.

In some embodiments, the value of the inherited LIC flag of a merge candidate is true, and a second template matching cost with LIC flag being true is modified by multiplying a factor, the factor being less than a predetermined integer.

In some embodiments, the predetermined integer comprises 1.

In some embodiments, the first variable comprises an inherited local illumination compensation (LIC) flag, and adjusting the value of the first variable based on a criterion comprises: in response to the inherited LIC flag being false, adjusting the value of LIC flag based on a comparison between a first template matching cost with LIC flag being false and a second template matching cost with LIC flag being true; and in response to the inherited LIC flag being true, setting the value of LIC flag to be a value of the inherited LIC flag.

In some embodiments, the first variable comprises an inherited local illumination compensation (LIC) flag, and adjusting the value of the first variable based on a criterion comprises: in response to the inherited LIC flag being true, adjusting the value of LIC flag based on a comparison between a first template matching cost with LIC flag being false and a second template matching cost with LIC flag being true; and in response to the inherited LIC flag being false, setting the value of LIC flag to be a value of the inherited LIC flag.

In some embodiments, the first template matching cost with LIC flag being false and the second template matching cost with LIC flag being true are determined based on a sum of absolute differences (SAD).

In some embodiments, for the LIC flag being true, an LIC operation is applied to a reference template of the current video block.

In some embodiments, an above template and a left template of the current video block share a group of LIC parameters.

In some embodiments, an above template of the current video block has a first group of LIC parameters, and a left template of the current video block has a second group of LIC parameters different from the first group of LIC parameters.

In some embodiments, the criterion is based on at least one of: a current template of the current video block, or a reference template of a reference block of the current video block.

In some embodiments, the criterion comprises a template matching cost.

In some embodiments, the template matching cost is based on a cost metric between the current template and the reference template, the cost metric comprising one of: a sum of absolute differences (SAD), a mean-removed sum of absolute differences (MR-SAD), a sum of absolute transformed differences (SATD), a mean-removed sum of absolute transformed differences (MR-SATD), a sum of squared differences (SSD), a mean-removed sum of squared differences (MR-SSD), sum of squared error (SSE), a mean-removed sum of squared error (MR-SSE), a weighted SAD, a weighted MR-SAD, a weighted SATD, a weighted MR-SATD, a weighted SSD, a weighted MR-SSD, a weighted SSE, or a weighted MR-SSE.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a merge candidate of a current video block of the video, a value of a first variable being inherited by the merge candidate: adjusting the value of the first variable based on a criterion; and generating the bitstream based on the adjusted value of the first variable.

According to still further embodiments of the present disclosure, a method for storing bitstream of a video is provided. The method comprises: determining a merge candidate of a current video block of the video, a value of a first variable being inherited by the merge candidate: adjusting the value of the first variable based on a criterion: generating the bitstream based on the adjusted value of the first variable; and storing the bitstream in a non-transitory computer-readable recording medium.

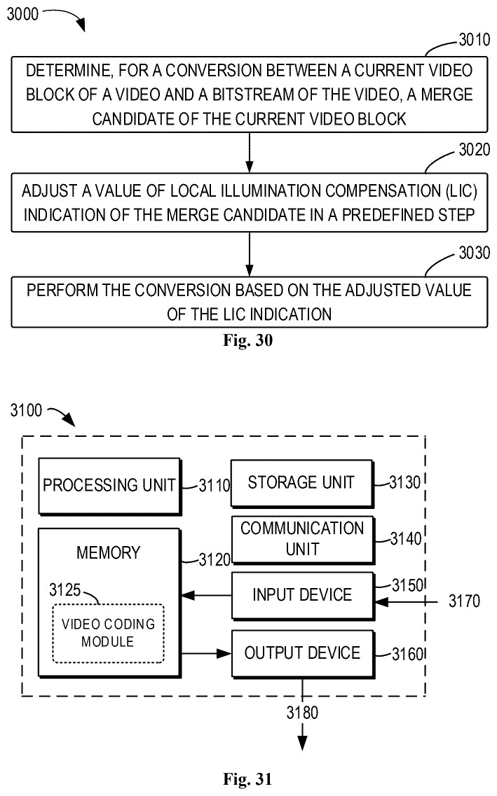

FIG. 30 illustrates a flowchart of a method 3000 for video processing in accordance with embodiments of the present disclosure. The method 3000 is implemented during a conversion between a video unit or video block of a video and a bitstream of the video.

At block 3010, for a conversion between a current video block of a video and a bitstream of the video, a merge candidate of the current video block is determined.

At block 3020, a value of local illumination compensation (LIC) indication of the merge candidate is adjusted in a predefined step.

At block 3030, the conversion is performed based on the adjusted value of the LIC indication. In some embodiments, the conversion may include encoding the current video block into the bitstream. Alternatively, or in addition, the conversion may include decoding the current video block from the bitstream.

The method 3000 enables adjusting the LIC indication in a predefined step. The coding effectiveness and/or coding efficiency can thus be improved.

In some embodiments, the value of the LIC indication is adjusted directly after constructing a merge candidate list of the current video block, the merge candidate list comprising the merge candidate.

In some embodiments, a merge candidate list of the current video block has a reordering operation, and the value of the LIC indication is adjusted directly after reordering the merge candidate list, the merge candidate list comprising the merge candidate.

In some embodiments, the merge candidate is bi-predicted, and the value of the LIC indication is adjusted directly after an adjustment of bi-prediction with coding unit (CU) level weight (BCW) index of the merge candidate.

In some embodiments, the merge candidate has a decoder-side motion vector refinement (DMVR) process or a multi-pass DMVR process, and the value of the LIC indication of the merge candidate is adjusted before the DMVR process or the multi-pass DMVR process.

In some embodiments, the merge candidate has a decoder-side motion vector refinement (DMVR) process or a multi-pass DMVR process, and the value of the LIC indication of the merge candidate is adjusted after the DMVR process or the multi-pass DMVR process.

In some embodiments, the merge candidate comprises a template matching (TM)-merge candidate, the value of the LIC indication of the TM-merge candidate is adjusted before a template matching refinement process of the TM-merge candidate.

In some embodiments, the merge candidate comprises a template matching (TM)-merge candidate, the value of the LIC indication of the TM-merge candidate is adjusted after a template matching refinement process of the TM-merge candidate.

In some embodiments, the merge candidate comprises an intra block copy with template matching (IBC-TM) merge candidate, the value of the LIC indication of the IBC-TM merge candidate is adjusted before a template matching refinement process of the TM-merge candidate.

In some embodiments, the merge candidate comprises an intra block copy with template matching (IBC-TM) merge candidate, the value of the LIC indication of the IBC-TM merge candidate is adjusted after a template matching refinement process of the TM-merge candidate.

In some embodiments, values of LIC indication for a plurality of merge candidates of the current video block are adjusted at an encoder and a decoder for the conversion.

In some embodiments, values of LIC indication for a plurality of merge candidates of the current video block are adjusted at an encoder for the conversion, and a partial of the values of LIC indication for at least one selected merge candidate of the plurality of merge candidates is adjusted at a decoder for the conversion, at least one index of the at least one selected merge candidate being included in the bitstream.

In some embodiments, the plurality of merge candidates comprises all merge candidates of the current video block.

In some embodiments, whether to adjust the value of the LIC indication of the merge candidate is predefined.

In some embodiments, whether to adjust the value of the LIC indication of the merge candidate is indicated in the bitstream.

In some embodiments, the LIC indication comprises at least one of: an LIC flag, an LIC index, or a further indication regarding LIC.

In some embodiments, a syntax element in the bitstream is binarized as one of: a flag, a fixed length code, an exponential Golomb(x) (EG(x)) code, a unary code, a truncated unary code, or a truncated binary code, and the syntax element is signed or unsigned.

In some embodiments, a syntax element in the bitstream is coded with at least one context model or bypass coded.

In some embodiments, a syntax element is included in the bitstream based on at least one condition, the at least one condition comprising a condition that a function associated with the syntax element is applicable for the conversion.

In some embodiments, a syntax element is included at one of: a block level, a sequence level, a group of pictures level, a picture level, a slice level, a tile group level, or a coding structure, the coding structure comprising one of: a coding tree unit (CTU), a coding unit (CU), a prediction unit (PU), a transform unit (TU), a coding tree block (CTB), a coding block (CB), a transform block (TB), a prediction block (PB), a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

In some embodiments, the current video block refers to one of: a color component, a sub-picture, a slice, a tile, a coding tree unit (CTU), a CTU row, groups of CTU, a coding unit (CU), a prediction unit (PU), a transform unit (TU), a coding tree block (CTB), a coding block (CB), a transform block (TB), a prediction block (PB), a block, a sub-block of a block, a sub-region within a block, or a region containing more than one sample or pixel.

In some embodiments, whether to and/or how to apply the method 2900 and/or the method 3000 is included in the bitstream at one of: a sequence level, a group of pictures level, a picture level, a slice level, a tile group level, a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

In some embodiments, whether to and/or how to apply the method 2900 and/or the method 3000 is included at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture, or a region containing more than one sample or pixel.

In some embodiments, whether to and/or how to apply the method 2900 and/or the method 3000 is based on coded information, the coded information comprising at least one of: a block size, a color format, a single or dual tree partitioning, a color component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a merge candidate of a current video block of the video: adjusting a value of local illumination compensation (LIC) indication of the merge candidate in a predefined step; and generating the bitstream based on the adjusted value of the LIC indication.

According to still further embodiments of the present disclosure, a method for storing bitstream of a video is provided. The method comprises: determining a merge candidate of a current video block of the video: adjusting a value of local illumination compensation (LIC) indication of the merge candidate in a predefined step: generating the bitstream based on the adjusted value of the LIC indication; and storing the bitstream in a non-transitory computer-readable recording medium.

It is to be understood that the method 2900 and/or the method 3000 can be applied separately, or in any combination. With the method 2900 and/or the method 3000, the coding effectiveness and/or the coding efficiency can be improved.

Implementations of the present disclosure can be described in view of the following clauses, the features of which can be combined in any reasonable manner.

Clause 1. A method for video processing, comprising: determining, for a conversion between a current video block of a video and a bitstream of the video, a merge candidate of the current video block, a value of a first variable being inherited by the merge candidate: adjusting the value of the first variable based on a criterion; and performing the conversion based on the adjusted value of the first variable.

Clause 2. The method of clause 1, wherein the first variable comprises a parameter associated with a local illumination compensation (LIC).

Clause 3. The method of clause 2, wherein the parameter associated with LIC comprises at least one of: an LIC flag, an LIC index, an LIC indication, or an intra block copy (IBC) with LIC (IBC-LIC) indication.

Clause 4. The method of any of clauses 1-3, wherein adjusting the value of the first variable based on the criterion comprises: determining a first template matching cost based on a first metric: determining a second template matching cost based on a second metric; and adjusting the value of first variable based on a comparison of the first and second template matching costs.

Clause 5. The method of clause 4, wherein the first variable comprises a local illumination compensation (LIC) flag, the first metric comprises a sum of absolute differences (SAD), and the second metric comprises a mean-removed sum of absolute differences (MR-SAD), and adjusting the value of the first variable based on the comparison comprises: in accordance with a determination that the first template matching cost is less than or equal to the second template matching cost, determining the value of the LIC flag as false, and in accordance with a determination that the first template matching cost is greater than the second template matching cost, determining the value of the LIC flag as true.

Clause 6. The method of clause 5, wherein an LIC operation is not performed for a reference template, the first template matching cost is determined with the LIC flag being false, and the second template matching cost is determined with the LIC flag being true.

Clause 7. The method of clause 4, wherein at least one of the first template matching cost or the second template matching cost is modified by multiplying a factor.

Clause 8. The method of clause 7, wherein if the value of the inherited LIC flag is false, the first template matching cost is modified by multiplying the factor, and/or wherein if the value of the inherited LIC flag is true, the second template matching cost is modified by multiplying the factor.

Clause 9. The method of clause 1, wherein the first variable comprises an inherited local illumination compensation (LIC) flag, and a template matching cost of the inherited LIC flag is modified by a factor.

Clause 10. The method of clause 9, wherein the factor is smaller than a threshold value, the threshold value comprising 1.

Clause 11. The method of clause 9, wherein the factor comprises one of: ¾, ½, ¼, or ⅛.

Clause 12. The method of clause 9, wherein the template matching cost is modified by at least a multiplication based on the factor and a shift operation.

Clause 13. The method of clause 12, wherein the template matching cost is modified by: tmCost=(tmCost*F+Offset)>>S, where tmCost denotes the template matching cost, tmCost′ denotes the modified template matching cost, F, Offset and S are integers.

Clause 14. The method of clause 13, wherein Offset=1<<(S−1).

Clause 15. The method of clause 13, wherein the factor is determined as (F+Offset)>>S.

Clause 16. The method of clause 9, wherein the factor is different for a plurality of picture types, the plurality of picture types comprising a low delay picture type and a non-low delay picture type.

Clause 17. The method of clause 16, wherein a picture type of a current picture containing the current video block is based on whether a backward inter-prediction is applied for the current picture.

Clause 18. The method of clause 17, wherein the backward inter-prediction refers to the current picture having a reference picture, a picture of order count of the reference picture being larger than a picture of order count of the current picture.

Clause 19. The method of clause 17, wherein the current picture with the backward inter-prediction is a non-low delay picture.

Clause 20. The method of clause 17, wherein the current picture without the backward inter-prediction is a low delay picture.

Clause 21. The method of clause 16, wherein for a uni-prediction merge candidate of inter merge mode, the template matching cost is modified by the factor of ½ for a non-low delay picture, and the template matching cost is modified by the factor of ¾ for a low delay picture.

Clause 22. The method of clause 9, wherein the factor is the same for different picture types.

Clause 23. The method of clause 9, wherein the factor is different for different prediction directions of merge candidates.

Clause 24. The method of clause 23, wherein a first factor for a uni-prediction merge candidate is different from a second factor for a bi-prediction merge candidate, the first and second factors being used for modifying corresponding template matching costs.

Clause 25. The method of clause 24, wherein the second factor is smaller than the first factor.

Clause 26. The method of clause 24, wherein the second factor is ¼, and the first factor is ½.

Clause 27. The method of clause 9, wherein the factor is the same for different prediction directions.

Clause 28. The method of clause 9, wherein the factor is different for different merge modes.

Clause 29. The method of clause 28, wherein a first factor for inter merge mode is different from a second factor for affine merge mode, and the first or second factor is different from a third factor for an intra block copy (IBC) merge mode, the first, second and third factor being used for modifying corresponding template matching costs.

Clause 30. The method of clause 28, wherein factors for modifying template matching costs are different for at least two of: a regular merge mode, a merge mode with motion vector differences (MMVD) mode, a combined inter and intra prediction (CIIP) mode, a template matching (TM)-merge mode, a CIIP with TM (CIIP-TM) merge mode, an adaptive decoder-side motion vector refinement (ADMVR) merge mode, or a bilateral matching advanced motion vector prediction (AMVP) merge mode.

Clause 31. The method of clause 28, wherein factors for modifying template matching costs are different for at least two of: an affine merge mode, an affine template matching (TM) merge mode, or an affine merge mode with motion vector differences (MMVD) mode.

Clause 32. The method of clause 28, wherein factors for modifying template matching costs are different for at least two of: an intra block copy (IBC) merge mode, an IBC with template matching (TM) (IBC-TM) merge mode, or an IBC merge mode with block vector differences (IBC-MBVD) mode.

Clause 33. The method of clause 9, wherein the factor is the same for different merge modes.

Clause 34. The method of clause 9, wherein the factor is different for different inherited LIC flags.

Clause 35. The method of clause 34, wherein the factor of the inherited LIC flag being tree is larger than the factor of the inherited LIC flag being false.

Clause 36. The method of clause 9, wherein the factor is the same for different inherited LIC flags.

Clause 37. The method of clause 9, wherein the factor is different for different sequence resolutions.

Clause 38. The method of clause 9, wherein the factor is the same for different sequence resolutions.

Clause 39. The method of clause 9, wherein the factor is different for different slice types.

Clause 40. The method of clause 9, wherein the factor is the same for different slice types.

Clause 41. The method of clause 9, wherein the factor is different for different coding configurations.

Clause 42. The method of clause 9, wherein the factor is the same for different coding configurations.

Clause 43. The method of clause 9, wherein the template matching cost of the inherited LIC flag is modified by one of:
tmCostInherited′=tmCostInherited-RightShift(tmCostInherited, 4)−RightShift(tmCostInherited, 5),
tmCostInherited′=tmCostInherited-RightShift(tmCostInherited, 3)−RightShift(tmCostInherited, 4),
tmCostInherited′=tmCostInherited−RightShift(tmCostInherited, 2),
tmCostInherited′=tmCostInherited−RightShift(tmCostInherited, 1),
tmCostInherited′=RightShift(tmCostInherited, 1),
tmCostInherited′=RightShift(tmCostInherited, 2), or
tmCostInherited′=RightShift(tmCostInherited, 3),
   where tmCostInherited denotes the template matching cost of the inherited LIC flag, tmCostInherited′ denotes the modified template matching cost, Right Shift denotes a shifting operation.

Clause 44. The method of clause 43, wherein the shifting operation comprises RightShift(X, S)=(X+offset)>>S, where offset is an integer, offset=1<<(S−1), S being a parameter.

Clause 45. The method of clause 43, wherein the template matching cost of the inherited LIC flag is modified by tmCostInherited′=tmCostInherited−RightShift(tmCostInherited, 2), the factor for modifying the template matching cost being ¾, or wherein the template matching cost of the inherited LIC flag is modified by tmCostInherited=tmCostInherited−RightShift(tmCostInherited, 1), the factor for modifying the template matching cost being ½.

Clause 46. The method of any of clauses 9-45, wherein whether to and/or how to modify the template matching cost is based on a value of the inherited LIC flag.

Clause 47. The method of clause 46, wherein the value of the inherited LIC flag of a merge candidate is false, and a first template matching cost with LIC flag being false is modified by multiplying a factor, the factor being less than a predetermined integer.

Clause 48. The method of clause 46, wherein the value of the inherited LIC flag of a merge candidate is false, and a second template matching cost with LIC flag being true is modified by multiplying a factor, the factor being larger than a predetermined integer.

Clause 49. The method of clause 46, wherein the value of the inherited LIC flag of a merge candidate is true, and a first template matching cost with LIC flag being false is modified by multiplying a factor, the factor being larger than a predetermined integer.

Clause 50. The method of clause 46, wherein the value of the inherited LIC flag of a merge candidate is true, and a second template matching cost with LIC flag being true is modified by multiplying a factor, the factor being less than a predetermined integer.

Clause 51. The method of any of clauses 47-50, wherein the predetermined integer comprises 1.

Clause 52. The method of clause 1, wherein the first variable comprises an inherited local illumination compensation (LIC) flag, and adjusting the value of the first variable based on a criterion comprises: in response to the inherited LIC flag being false, adjusting the value of LIC flag based on a comparison between a first template matching cost with LIC flag being false and a second template matching cost with LIC flag being true; and in response to the inherited LIC flag being true, setting the value of LIC flag to be a value of the inherited LIC flag.

Clause 53. The method of clause 1, wherein the first variable comprises an inherited local illumination compensation (LIC) flag, and adjusting the value of the first variable based on a criterion comprises: in response to the inherited LIC flag being true, adjusting the value of LIC flag based on a comparison between a first template matching cost with LIC flag being false and a second template matching cost with LIC flag being true; and in response to the inherited LIC flag being false, setting the value of LIC flag to be a value of the inherited LIC flag.

Clause 54. The method of clause 52 or 53, wherein the first template matching cost with LIC flag being false and the second template matching cost with LIC flag being true are determined based on a sum of absolute differences (SAD).

Clause 55. The method of clause 54, wherein for the LIC flag being true, an LIC operation is applied to a reference template of the current video block.

Clause 56. The method of clause 54, wherein an above template and a left template of the current video block share a group of LIC parameters.

Clause 57. The method of clause 54, wherein an above template of the current video block has a first group of LIC parameters, and a left template of the current video block has a second group of LIC parameters different from the first group of LIC parameters.

Clause 58. The method of clause 1, wherein the criterion is based on at least one of: a current template of the current video block, or a reference template of a reference block of the current video block.

Clause 59. The method of clause 58, wherein the criterion comprises a template matching cost.

Clause 60. The method of clause 59, wherein the template matching cost is based on a cost metric between the current template and the reference template, the cost metric comprising one of: a sum of absolute differences (SAD), a mean-removed sum of absolute differences (MR-SAD), a sum of absolute transformed differences (SATD), a mean-removed sum of absolute transformed differences (MR-SATD), a sum of squared differences (SSD), a mean-removed sum of squared differences (MR-SSD), sum of squared error (SSE), a mean-removed sum of squared error (MR-SSE), a weighted SAD, a weighted MR-SAD, a weighted SATD, a weighted MR-SATD, a weighted SSD, a weighted MR-SSD, a weighted SSE, or a weighted MR-SSE.

Clause 61. A method for video processing, comprising: determining, for a conversion between a current video block of a video and a bitstream of the video, a merge candidate of the current video block; adjusting a value of local illumination compensation (LIC) indication of the merge candidate in a predefined step; and performing the conversion based on the adjusted value of the LIC indication.

Clause 62. The method of clause 61, wherein the value of the LIC indication is adjusted directly after constructing a merge candidate list of the current video block, the merge candidate list comprising the merge candidate.

Clause 63. The method of clause 61, wherein a merge candidate list of the current video block has a reordering operation, and the value of the LIC indication is adjusted directly after reordering the merge candidate list, the merge candidate list comprising the merge candidate.

Clause 64. The method of clause 61, wherein the merge candidate is bi-predicted, and the value of the LIC indication is adjusted directly after an adjustment of bi-prediction with coding unit (CU) level weight (BCW) index of the merge candidate.

Clause 65. The method of clause 61, wherein the merge candidate has a decoder-side motion vector refinement (DMVR) process or a multi-pass DMVR process, and the value of the LIC indication of the merge candidate is adjusted before the DMVR process or the multi-pass DMVR process.

Clause 66. The method of clause 61, wherein the merge candidate has a decoder-side motion vector refinement (DMVR) process or a multi-pass DMVR process, and the value of the LIC indication of the merge candidate is adjusted after the DMVR process or the multi-pass DMVR process.

Clause 67. The method of clause 61, wherein the merge candidate comprises a template matching (TM)-merge candidate, the value of the LIC indication of the TM-merge candidate is adjusted before a template matching refinement process of the TM-merge candidate.

Clause 68. The method of clause 61, wherein the merge candidate comprises a template matching (TM)-merge candidate, the value of the LIC indication of the TM-merge candidate is adjusted after a template matching refinement process of the TM-merge candidate.

Clause 69. The method of clause 61, wherein the merge candidate comprises an intra block copy with template matching (IBC-TM) merge candidate, the value of the LIC indication of the IBC-TM merge candidate is adjusted before a template matching refinement process of the TM-merge candidate.

Clause 70. The method of clause 61, wherein the merge candidate comprises an intra block copy with template matching (IBC-TM) merge candidate, the value of the LIC indication of the IBC-TM merge candidate is adjusted after a template matching refinement process of the TM-merge candidate.

Clause 71. The method of any of clauses 61-70, wherein values of LIC indication for a plurality of merge candidates of the current video block are adjusted at an encoder and a decoder for the conversion.

Clause 72. The method of any of clauses 61-70, wherein values of LIC indication for a plurality of merge candidates of the current video block are adjusted at an encoder for the conversion, and a partial of the values of LIC indication for at least one selected merge candidate of the plurality of merge candidates is adjusted at a decoder for the conversion, at least one index of the at least one selected merge candidate being included in the bitstream.

Clause 73. The method of clause 71 or 72, wherein the plurality of merge candidates comprises all merge candidates of the current video block.

Clause 74. The method of any of clauses 61-73, wherein whether to adjust the value of the LIC indication of the merge candidate is predefined.

Clause 75. The method of any of clauses 61-73, wherein whether to adjust the value of the LIC indication of the merge candidate is indicated in the bitstream.

Clause 76. The method of any of clauses 61-75, wherein the LIC indication comprises at least one of: an LIC flag, an LIC index, or a further indication regarding LIC.

Clause 77. The method of any of clauses 1-76, wherein a syntax element in the bitstream is binarized as one of: a flag, a fixed length code, an exponential Golomb(x) (EG(x)) code, a unary code, a truncated unary code, or a truncated binary code, and the syntax element is signed or unsigned.

Clause 78. The method of any of clauses 1-77, wherein a syntax element in the bitstream is coded with at least one context model or bypass coded.

Clause 79. The method of any of clauses 1-78, wherein a syntax element is included in the bitstream based on at least one condition, the at least one condition comprising a condition that a function associated with the syntax element is applicable for the conversion.

Clause 80. The method of any of clauses 1-79, wherein a syntax element is included at one of: a block level, a sequence level, a group of pictures level, a picture level, a slice level, a tile group level, or a coding structure, the coding structure comprising one of: a coding tree unit (CTU), a coding unit (CU), a prediction unit (PU), a transform unit (TU), a coding tree block (CTB), a coding block (CB), a transform block (TB), a prediction block (PB), a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

Clause 81. The method of any of clauses 1-80, wherein the current video block refers to one of: a color component, a sub-picture, a slice, a tile, a coding tree unit (CTU), a CTU row, groups of CTU, a coding unit (CU), a prediction unit (PU), a transform unit (TU), a coding tree block (CTB), a coding block (CB), a transform block (TB), a prediction block (PB), a block, a sub-block of a block, a sub-region within a block, or a region containing more than one sample or pixel.

Clause 82. The method of any of clauses 1-81, wherein whether to and/or how to apply the method is included in the bitstream at one of: a sequence level, a group of pictures level, a picture level, a slice level, a tile group level, a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

Clause 83. The method of any of clauses 1-81, wherein whether to and/or how to apply the method is included at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture, or a region containing more than one sample or pixel.

Clause 84. The method of any of clauses 1-81, wherein whether to and/or how to apply the method is based on coded information, the coded information comprising at least one of: a block size, a color format, a single or dual tree partitioning, a color component, a slice type, or a picture type.

Clause 85. The method of any of clauses 1-84, wherein the conversion includes encoding the current video block into the bitstream.

Clause 86. The method of any of clauses 1-84, wherein the conversion includes decoding the current video block from the bitstream.

Clause 87. An apparatus for video processing comprising a processor and a non-transitory memory with instructions thereon, wherein the instructions upon execution by the processor, cause the processor to perform a method in accordance with any of clauses 1-86.

Clause 88. A non-transitory computer-readable storage medium storing instructions that cause a processor to perform a method in accordance with any of clauses 1-86.

Clause 89. A non-transitory computer-readable recording medium storing a bitstream of a video which is generated by a method performed by an apparatus for video processing, wherein the method comprises: determining a merge candidate of a current video block of the video, a value of a first variable being inherited by the merge candidate: adjusting the value of the first variable based on a criterion; and generating the bitstream based on the adjusted value of the first variable.

Clause 90. A method for storing a bitstream of a video, comprising: determining a merge candidate of a current video block of the video, a value of a first variable being inherited by the merge candidate; adjusting the value of the first variable based on a criterion: generating the bitstream based on the adjusted value of the first variable; and storing the bitstream in a non-transitory computer-readable recording medium.

Clause 91. A non-transitory computer-readable recording medium storing a bitstream of a video which is generated by a method performed by an apparatus for video processing, wherein the method comprises: determining a merge candidate of a current video block of the video: adjusting a value of local illumination compensation (LIC) indication of the merge candidate in a predefined step; and generating the bitstream based on the adjusted value of the LIC indication.

Clause 92. A method for storing a bitstream of a video, comprising: determining a merge candidate of a current video block of the video: adjusting a value of local illumination compensation (LIC) indication of the merge candidate in a predefined step: generating the bitstream based on the adjusted value of the LIC indication; and storing the bitstream in a non-transitory computer-readable recording medium.

### Example Device

FIG. 31 illustrates a block diagram of a computing device 3100 in which various embodiments of the present disclosure can be implemented. The computing device 3100 may be implemented as or included in the source device 110 (or the video encoder 114 or 200) or the destination device 120 (or the video decoder 124 or 300).

It would be appreciated that the computing device 3100 shown in FIG. 31 is merely for purpose of illustration, without suggesting any limitation to the functions and scopes of the embodiments of the present disclosure in any manner.

As shown in FIG. 31, the computing device 3100 includes a general-purpose computing device 3100. The computing device 3100 may at least comprise one or more processors or processing units 3110, a memory 3120, a storage unit 3130), one or more communication units 3140), one or more input devices 3150, and one or more output devices 3160).

In some embodiments, the computing device 3100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3100 can support any type of interface to a user (such as “wearable” circuitry and the like).

The processing unit 3110 may be a physical or virtual processor and can implement various processes based on programs stored in the memory 3120. In a multi-processor system, multiple processing units execute computer executable instructions in parallel so as to improve the parallel processing capability of the computing device 3100. The processing unit 3110 may also be referred to as a central processing unit (CPU), a microprocessor, a controller or a microcontroller.

The computing device 3100 typically includes various computer storage medium. Such medium can be any medium accessible by the computing device 3100, including, but not limited to, volatile and non-volatile medium, or detachable and non-detachable medium. The memory 3120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3130) may be any detachable or non-detachable medium and may include a machine-readable medium such as a memory, flash memory drive, magnetic disk or another other media, which can be used for storing information and/or data and can be accessed in the computing device 3100.

The computing device 3100 may further include additional detachable/non-detachable, volatile/non-volatile memory medium. Although not shown in FIG. 31, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3140 communicates with a further computing device via the communication medium. In addition, the functions of the components in the computing device 3100 can be implemented by a single computing cluster or multiple computing machines that can communicate via communication connections. Therefore, the computing device 3100 can operate in a networked environment using a logical connection with one or more other servers, networked personal computers (PCs) or further general network nodes.

The input device 3150 may be one or more of a variety of input devices, such as a mouse, keyboard, tracking ball, voice-input device, and the like. The output device 3160 may be one or more of a variety of output devices, such as a display, loudspeaker, printer, and the like. By means of the communication unit 3140, the computing device 3100 can further communicate with one or more external devices (not shown) such as the storage devices and display device, with one or more devices enabling the user to interact with the computing device 3100, or any devices (such as a network card, a modem and the like) enabling the computing device 3100 to communicate with one or more other computing devices, if required. Such communication can be performed via input/output (I/O) interfaces (not shown).

In some embodiments, instead of being integrated in a single device, some or all components of the computing device 3100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3100 may be used to implement video encoding/decoding in embodiments of the present disclosure. The memory 3120 may include one or more video coding modules 3125 having one or more program instructions. These modules are accessible and executable by the processing unit 3110 to perform the functionalities of the various embodiments described herein.

In the example embodiments of performing video encoding, the input device 3150 may receive video data as an input 3170 to be encoded. The video data may be processed, for example, by the video coding module 3125, to generate an encoded bitstream. The encoded bitstream may be provided via the output device 3160 as an output 3180.

In the example embodiments of performing video decoding, the input device 3150 may receive an encoded bitstream as the input 3170. The encoded bitstream may be processed, for example, by the video coding module 3125, to generate decoded video data. The decoded video data may be provided via the output device 3160 as the output 3180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, a merge candidate of the current video block, a value of a first variable being inherited by the merge candidate;
adjusting the value of the first variable based on a criterion; and
performing the conversion based on the adjusted value of the first variable.

2. The method of claim 1, wherein the first variable comprises a parameter associated with a local illumination compensation (LIC),
wherein the parameter associated with LIC comprises at least one of: an LIC flag, an LIC index, an LIC indication, or an intra block copy (IBC) with LIC (IBC-LIC) indication.

3. The method of claim 1, wherein adjusting the value of the first variable based on the criterion comprises:
determining a first template matching cost based on a first metric;
determining a second template matching cost based on a second metric; and
adjusting the value of first variable based on a comparison of the first and second template matching costs,
wherein the first variable comprises a local illumination compensation (LIC) flag, the first metric comprises a sum of absolute differences (SAD), and the second metric comprises a mean-removed sum of absolute differences (MR-SAD), and adjusting the value of the first variable based on the comparison comprises:
in accordance with a determination that the first template matching cost is less than or equal to the second template matching cost, determining the value of the LIC flag as false, and
in accordance with a determination that the first template matching cost is greater than the second template matching cost, determining the value of the LIC flag as true, wherein an LIC operation is not performed for a reference template, the first template matching cost is determined with the LIC flag being false, and the second template matching cost is determined with the LIC flag being true, or
wherein at least one of the first template matching cost or the second template matching cost is modified by multiplying a factor, wherein if the value of the inherited LIC flag is false, the first template matching cost is modified by multiplying the factor, and/or wherein if the value of the inherited LIC flag is true, the second template matching cost is modified by multiplying the factor.

4. The method of claim 1, wherein the first variable comprises an inherited local illumination compensation (LIC) flag, and a template matching cost of the inherited LIC flag is modified by a factor.

5. The method of claim 4, wherein the factor is smaller than a threshold value, the threshold value comprising 1,
wherein the factor comprises one of: ¾, ½, ¼, or ⅛, and/or
wherein the template matching cost is modified by at least a multiplication based on the factor and a shift operation, wherein the template matching cost is modified by: tmCost′=(tmCost*F+Offset)>>S, where tmCost denotes the template matching cost, tmCost′ denotes the modified template matching cost, F, Offset and S are integers, wherein Offset=1<<(S−1), wherein the factor is determined as (F+Offset)>>S.

6. The method of claim 4, wherein the factor is different for a plurality of picture types, the plurality of picture types comprising a low delay picture type and a non-low delay picture type, wherein a picture type of a current picture containing the current video block is based on whether a backward inter-prediction is applied for the current picture, wherein the backward inter-prediction refers to the current picture having a reference picture, a picture of order count of the reference picture being larger than a picture of order count of the current picture, wherein the current picture with the backward inter-prediction is a non-low delay picture, or wherein the current picture without the backward inter-prediction is a low delay picture, or
wherein for a uni-prediction merge candidate of inter merge mode, the template matching cost is modified by the factor of ½ for a non-low delay picture, and the template matching cost is modified by the factor of ¾ for a low delay picture.

7. The method of claim 4, wherein the factor is the same for different picture types, or
wherein the factor is different for different prediction directions of merge candidates, wherein a first factor for a uni-prediction merge candidate is different from a second factor for a bi-prediction merge candidate, the first and second factors being used for modifying corresponding template matching costs, wherein the second factor is smaller than the first factor, or wherein the second factor is ¼, and the first factor is ½.

8. The method of claim 4, wherein the factor is the same for different prediction directions, or
wherein the factor is different for different merge modes, wherein a first factor for inter merge mode is different from a second factor for affine merge mode, and the first or second factor is different from a third factor for an intra block copy (IBC) merge mode, the first, second and third factor being used for modifying corresponding template matching costs, or wherein factors for modifying template matching costs are different for at least two of: a regular merge mode, a merge mode with motion vector differences (MMVD) mode, a combined inter and intra prediction (CIIP) mode, a template matching (TM)-merge mode, a CIIP with TM (CIIP-TM) merge mode, an adaptive decoder-side motion vector refinement (ADMVR) merge mode, or a bilateral matching advanced motion vector prediction (AMVP) merge mode, or wherein factors for modifying template matching costs are different for at least two of: an affine merge mode, an affine template matching (TM) merge mode, or an affine merge mode with motion vector differences (MMVD) mode, or wherein factors for modifying template matching costs are different for at least two of: an intra block copy (IBC) merge mode, an IBC with template matching (TM) (IBC-TM) merge mode, or an IBC merge mode with block vector differences (IBC-MBVD) mode.

9. The method of claim 4, wherein the factor is the same for different merge modes, or
wherein the factor is different for different inherited LIC flags, wherein the factor of the inherited LIC flag being tree is larger than the factor of the inherited LIC flag being false.

10. The method of claim 4, wherein the factor is the same for different inherited LIC flags, and/or
wherein the factor is different for different sequence resolutions, or wherein the factor is the same for different sequence resolutions, and/or
wherein the factor is different for different slice types, or wherein the factor is the same for different slice types, and/or
wherein the factor is different for different coding configurations, or wherein the factor is the same for different coding configurations.

11. The method of claim 4, wherein the template matching cost of the inherited LIC flag is modified by one of:
tmCostInherited′=tmCostInherited−RightShift(tmCostInherited, 4)−RightShift(tmCostInherited, 5),
tmCostInherited′=tmCostInherited−RightShift(tmCostInherited, 3)−RightShift(tmCostInherited, 4),
tmCostInherited′=tmCostInherited−RightShift(tmCostInherited, 2),
tmCostInherited′=tmCostInherited−RightShift(tmCostInherited, 1),
tmCostInherited′=RightShift(tmCostInherited, 1),
tmCostInherited′=RightShift(tmCostInherited, 2), or
tmCostInherited′=RightShift(tmCostInherited, 3),
where tmCostInherited denotes the template matching cost of the inherited LIC flag, tmCostInherited′ denotes the modified template matching cost, RightShift denotes a shifting operation, and/or
wherein the shifting operation comprises RightShift(X, S)=(X+offset)>>S, where offset is an integer, offset=1<<(S−1), S being a parameter, and/or
wherein the template matching cost of the inherited LIC flag is modified by tmCostInherited′=tmCostInherited−RightShift(tmCostInherited, 2), the factor for modifying the template matching cost being ¾, or
wherein the template matching cost of the inherited LIC flag is modified by tmCostInherited′=tmCostInherited−RightShift(tmCostInherited, 1), the factor for modifying the template matching cost being ½.

12. The method of claim 4, wherein whether to and/or how to modify the template matching cost is based on a value of the inherited LIC flag,
wherein the value of the inherited LIC flag of a merge candidate is false, and a first template matching cost with LIC flag being false is modified by multiplying a factor, the factor being less than a predetermined integer, or
wherein the value of the inherited LIC flag of a merge candidate is false, and a second template matching cost with LIC flag being true is modified by multiplying a factor, the factor being larger than a predetermined integer, or
wherein the value of the inherited LIC flag of a merge candidate is true, and a first template matching cost with LIC flag being false is modified by multiplying a factor, the factor being larger than a predetermined integer, or
wherein the value of the inherited LIC flag of a merge candidate is true, and a second template matching cost with LIC flag being true is modified by multiplying a factor, the factor being less than a predetermined integer, wherein the predetermined integer comprises 1.

13. The method of claim 1, wherein the first variable comprises an inherited local illumination compensation (LIC) flag, and adjusting the value of the first variable based on a criterion comprises:
in response to the inherited LIC flag being false, adjusting the value of LIC flag based on a comparison between a first template matching cost with LIC flag being false and a second template matching cost with LIC flag being true; and
in response to the inherited LIC flag being true, setting the value of LIC flag to be a value of the inherited LIC flag.

14. The method of claim 1, wherein the first variable comprises an inherited local illumination compensation (LIC) flag, and adjusting the value of the first variable based on a criterion comprises:
in response to the inherited LIC flag being true, adjusting the value of LIC flag based on a comparison between a first template matching cost with LIC flag being false and a second template matching cost with LIC flag being true; and
in response to the inherited LIC flag being false, setting the value of LIC flag to be a value of the inherited LIC flag,
wherein the first template matching cost with LIC flag being false and the second template matching cost with LIC flag being true are determined based on a sum of absolute differences (SAD),
wherein for the LIC flag being true, an LIC operation is applied to a reference template of the current video block, or
wherein an above template and a left template of the current video block share a group of LIC parameters, or
wherein an above template of the current video block has a first group of LIC parameters, and a left template of the current video block has a second group of LIC parameters different from the first group of LIC parameters.

15. The method of claim 1, wherein the criterion is based on at least one of: a current template of the current video block, or a reference template of a reference block of the current video block,
wherein the criterion comprises a template matching cost.

16. The method of claim 15, wherein the template matching cost is based on a cost metric between the current template and the reference template, the cost metric comprising one of:
a sum of absolute differences (SAD),
a mean-removed sum of absolute differences (MR-SAD),
a sum of absolute transformed differences (SATD),
a mean-removed sum of absolute transformed differences (MR-SATD),
a sum of squared differences (SSD),
a mean-removed sum of squared differences (MR-SSD),
sum of squared error (SSE),
a mean-removed sum of squared error (MR-SSE),
a weighted SAD,
a weighted MR-SAD,
a weighted SATD,
a weighted MR-SATD,
a weighted SSD,
a weighted MR-SSD,
a weighted SSE, or
a weighted MR-SSE.

17. The method of claim 1, wherein the conversion includes encoding the current video block into the bitstream, or
wherein the conversion includes decoding the current video block from the bitstream.

18. An apparatus for video processing comprising a processor and a non-transitory memory with instructions thereon, wherein the instructions upon execution by the processor, cause the processor to:
determine, for a conversion between a current video block of a video and a bitstream of the video, a merge candidate of the current video block, a value of a first variable being inherited by the merge candidate;
adjust the value of the first variable based on a criterion; and
perform the conversion based on the adjusted value of the first variable.

19. A non-transitory computer-readable storage medium storing instructions that cause a processor to perform operations comprising:
determining, for a conversion between a current video block of a video and a bitstream of the video, a merge candidate of the current video block, a value of a first variable being inherited by the merge candidate;
adjusting the value of the first variable based on a criterion; and
performing the conversion based on the adjusted value of the first variable.

20. A non-transitory computer-readable recording medium storing a bitstream of a video which is generated by a method performed by an apparatus for video processing, wherein the method comprises:
determining a merge candidate of a current video block of the video, a value of a first variable being inherited by the merge candidate;
adjusting the value of the first variable based on a criterion; and
generating the bitstream based on the adjusted value of the first variable.
